(19) United States
(12) Patent Application Publication
(10) Pub. No.: US 2023/0166227 A1
(43) Pub. Date: Jun. 1, 2023

(54) PLASMA/IONIC REACTOR

(71) Applicant: Cogent Energy Systems, Inc., Annandale, VA (US)

(72) Inventors: Peter C. Kong, Idaho Falls, ID (US); Rodney J. Bitsoi, Rigby, ID (US)

(21) Appl. No.: 18/073,265

(22) Filed: Dec. 1, 2022

Related U.S. Application Data
(60) Provisional application No. 63/426,110, filed on Nov. 17, 2022.
(60) Provisional application No. 63/296,209, filed on Jan. 4, 2022.
(60) Provisional application No. 63/286,681, filed on Dec. 7, 2021.
(60) Provisional application No. 63/285,076, filed on Dec. 1, 2021.

(51) Int. Cl. B01J 6/00; C01B 3/02; C10J 3/72

(52) U.S. Cl. CPC B01J 6/008; C01B 3/02; C10J 3/72; C10J 2300/1238

(57) ABSTRACT

A hybrid plasma or ionic reactor includes the basic components of both a plasma jet reactor and a plasma arc reactor, which components operate simultaneously to provide hot ionic gas and electrical arcing within a reaction chamber in a manner that significantly increases processing of material within the reaction chamber. Additionally, an improved plasma or ionic reactor uses multiple sets of arc electrodes disposed around a reaction chamber in a unique offset manner that operates to create a larger area in the center of the reaction or plasma chamber where the arcs travel between an anode and a cathode of a pair of electrodes, thereby effectively increasing the size of the reaction zone in which the arcs are present. Still further, an improved plasma or arc reactor includes structure to introduce, from multiple different electrodes, a working or cooling gas, used to cool the electrodes and provide for plasma creation within a reaction chamber, in a manner that causes the gas to flow in a sustained vortex across the width of the chamber, which aids in the creation of a confined or directed stream of gas within the reaction chamber which further aids in the creation of stable arcs in the chamber.

### RELATED APPLICATIONS

This application claims the benefit under 35 U.S.C. § 119(e) of U.S. Provisional Patent Application Ser. No. 63/285,076, entitled “Hybrid Plasma Jet and Plasma Arc System,” filed Dec. 1, 2021; U.S. Provisional Patent Application Ser. No. 63/286,681, entitled “Multi-Arc Plasma System for Use in Producing Carbon Nano-Structures and Cracking Hydrocarbons,” filed Dec. 7, 2021; U.S. Provisional Patent Application Ser. No. 63/296,209, entitled “Opposed Working Gas Flows for Plasma Arc Electrodes,” filed Jan. 4, 2022; and U.S. Provisional Patent Application Ser. No. 63/426,110, entitled “Plasma/Ionic Reactor for Processing PFAS,” filed Nov. 17, 2022; the entire disclosure of each of which is hereby expressly incorporated by reference herein.

### FIELD OF TECHNOLOGY

This patent relates generally to plasma arc or ionic reactors and/or gasifier systems and, more particularly, to an advanced plasma arc or ionic reactor used to gasify heterogeneous materials to produce various products, such as synthesis gas.

### DESCRIPTION OF RELATED ART

A plasma is commonly defined as a collection of charged particles containing equal numbers of positive ions and electrons, as well as excited neutrals. Although exhibiting some properties of a gas, a plasma is also a good conductor of electricity and can be affected by a magnetic field. One way to generate a plasma is to pass a gas through an electric arc. The arc heats the gas by resistive and radiative heating to very high temperatures within a fraction of a second. Essentially, any gas may be used to produce a plasma in such a manner. Thus, inert or neutral gases (e.g., argon, helium, neon, or nitrogen) may be used. Reductive gases (e.g., hydrogen, methane, ammonia, or carbon monoxide) may also be used, as may oxidative gases (e.g., oxygen or carbon dioxide) depending on how the plasma is to be utilized.

Plasma generators, which are known and have been used in conjunction with or as part of plasma torches, plasma jets and plasma arc reactors, generally create an electric discharge in a working gas to create the plasma. Plasma generators have been formed as direct current (DC) plasma generators, alternating current (AC) plasma generators, radio frequency (RF) plasma generators and microwave (MW) plasma generators. Plasmas generated with RF or MW sources are called inductively coupled plasmas. For example, an RF-type plasma generator includes an RF source and an induction coil surrounding a working gas. The RF signal sent from the source to the induction coil results in the ionization of the working gas by inductive coupling to produce the plasma. DC and AC type generators may include two or more electrodes (e.g., an anode and a cathode electrode) with a voltage applied between them. An arc may be formed between the electrodes to heat and ionize the surrounding gas such that the gas obtains a plasma state. The resulting plasma may then be used for a specified process application.

Plasma or ionic reactors, which use plasma generators, typically come in two types, including plasma jet reactors and plasma arc reactors. In a plasma jet reactor (typically referred to as a plasma torch), an arc is created between a cathode electrode and an anode electrode that are positioned close together inside a torch body. A working gas is then passed through the arc, therein creating a plume or flame of plasma which is then emitted from an output of the torch as a stream of hot plasma, typically into a reaction chamber. In a plasma arc reactor, a cathode and an anode are placed apart across, i.e., on opposite sides of, a reaction chamber of some sort. A working gas may be introduced to flow past or between the cathode and/or the anode to keep these elements cool. In these systems, an unconfined arc generated between the cathode and the anode electrodes transforms the working gas into plasma in a reaction chamber between the electrodes. Both plasma jet reactors and plasma arc reactors have advantages and disadvantages, depending upon use. None-the-less, plasma reactors of both types can be used for the high-temperature heating of material compounds to accommodate chemical or material processing. Such chemical and material processing may include the reduction and decomposition of hazardous materials. In other applications, plasma reactors have been utilized to assist in the extraction of a desired material, such as a metal or metal alloy, from a compound that contains the desired material.

However, process applications utilizing plasma generators or plasma reactors are often specialized. Consequently, the associated plasma reactors need to be designed and configured according to highly specific criteria mandated by the particular use to which the reactor is being put. Such specialized designs often result in a device with limited usefulness. In other words, a plasma reactor which is configured to process a specific type of material using a specified working gas is not likely to be suitable for use in other processes wherein a different material is being processed using a different working gas.

U.S. Pat. No. 10,208,263 describes an improved plasma gasifier system that generates electrical arcing within a circular or cylindrical reaction or processing chamber in which materials to be processed flow, using a set of circumferentially located electrodes surrounding the reaction chamber. The operation of the electrodes of this system create electrical arcing within the reaction chamber and so this system enables the direct contact between one or more electrical arcs and the materials being processed within the chamber, which provides for better heating of the materials being processed than previously known plasma reactors. More particularly, the '263 patent describes a modular DC-DC plasma reactor for industrial applications including gasification of biomass and non-biomass combustible materials to produce synthesis gas, which is mainly composed of carbon monoxide (CO) and hydrogen (H₂). The plasma reactor creates a large uniform high temperature (greater than 7000 degrees Kelvin) plasma with tailored long residence time for material processing. The plasma reactor has multiple sets of long electrodes that are placed radially opposite each other within modular plasma units, wherein the electrodes are disposed circumferentially around reaction chamber. The plasma units can be stacked to form an elongated plasma zone. As a result, materials to be processed can flow continuously from one modular plasma unit into the next, which creates an energy cascading effect from upstream plasma units towards downstream plasma units, such that the bottom-most modular plasma unit produces the brightest plasma illumination. Still further, each of the plasma units defines an internal plasma zone that is accessible through access ports. The electrode assemblies extend into the access ports and each of the electrode assemblies has an electrode tip that is positioned within the internal plasma zone at a selected insertion depth. Each electrode tip is mounted in a tubular support jacket such that a gas conduit for a supplied working gas surrounds at least a portion of the tubular support jacket. When an arc is created at the electrode tip, a working gas flows through the gas conduit and is directed into the arc, therein creating plasma within the internal reaction or plasma zone.

Moreover, this system has adjustable controls and provides improved flexibility regarding the plasma being generated within the reaction chamber, so that the plasma volume being generated may be easily adjusted and defined to optimize the plasma interactions. Still, further, U.S. Pat. No. 10,926,238 describes an improved electrode assembly that may be used in, for example, the '263 system to provide for improved cooling and control of the electrodes used therein.

### SUMMARY

A hybrid plasma or ionic reactor described herein includes the basic components of both a plasma jet reactor and a plasma arc reactor, which components operate simultaneously to provide hot ionic gas and electrical arcing within a reaction chamber in a manner that significantly increases processing of material within the reaction chamber. In one case, the hybrid plasma reactor system includes one or more sets of opposed electrodes extending into a reaction chamber and a plasma torch disposed on another side of the chamber, such as on the top of the chamber. The opposed electrodes operate to cause arcing and the creation of plasma gas in the reaction chamber in direct contact with a material being processed in the reaction chamber, while the plasma torch operates to create and direct additional plasma (generated in the plasma torch) into the reaction chamber. In this manner, the working material is subject to arcing and plasma created by the arc electrodes as well as to plasma created by the plasma torch, thereby increasing the heat and ionic activity to which the material being processed is exposed in the reaction chamber. The plasma torch may inject plasma into the chamber in a manner generally in line with or in a manner that is generally perpendicular or orthogonal to the arcing created by the arc electrodes to provide additional plasma and ionic reactions within the reaction chamber.

Still further, an improved plasma or ionic reactor described herein uses multiple sets of arc electrodes disposed around a reaction chamber in a unique manner that operates to create a larger area in the center of the reaction or plasma chamber where the arcs travel between an anode and a cathode of a pair of electrodes, thereby effectively increasing the size of the reaction zone in which the arcs are present. Generally, because an electrical arc is relatively small in size or cross section, the area within a reaction chamber exposed directly to a particular arc can be relatively small. The improved plasma or ionic reactor operates to produce enlarged arcing areas within a plasma or reaction chamber and to increase the temperature within those areas by disposing the anodes and cathodes of various pairs of electrodes at angles other than 180 degrees, such as acute angles, 90 degrees or obtuse angles with respect to one other so that the arcs produced by the electrodes do not necessarily travel through the center of the reaction chamber, and so that arcs produced by different sets of electrodes travel through the reaction chamber on various different paths through the chamber, thereby better distributing the arcs throughout the chamber. The disbursal of arcs more evenly throughout the reaction chamber provides for better or more even processing of the material flowing through the chamber and for a larger active reaction zone through which the material passes, which enables the chamber to be used for new purposes, such as producing carbon nanoparticles.

Still further, an improved plasma or arc reactor includes structure to introduce a working or cooling gas, used to cool the electrodes, within a reaction chamber in a manner that causes the gas to flow in a vortex, which aids in the creation of a confined or directed stream of gas within the reaction chamber. This directed stream of gas ionizes in response to the arcing and the vortex of the stream keeps the gas from disbursing as quickly, thereby exposing the gas to the arcing for a longer period of time which, in turn, promotes ionization of the gas. The ionized gas then assists in the processing of a material within the chamber. To help keep the working gas in a confined stream, a rotational vortex is created in the working gas as it flows into the plasma or reaction chamber, such that the mid-axis of the vortex is oriented to follow the path of the arc. However, in cases in which the cathode electrode and the anode electrode are positioned on directly opposite sides of a plasma chamber, applying the same rotational vortex in the gas being emitted by each of these electrodes causes the two vortexes to spin in opposite directions when they intersect in the center of the plasma or reaction chamber. This interaction may create significant instabilities for the arc column in the chamber, as the opposite spins of the gas vortexes cause the vortexes to cancel one another when the gas streams interact, which in turn causes the working gas to disperse more quickly. An improved plasma or ionic reactor described herein may emit the working gases from different electrodes into the reaction chamber such that these gases have oppositely directed vortexes, which enables the working gases to constructively add within the reaction chamber, thereby allowing for better or more directed gas flow through and arcing within the reaction chamber.

### BRIEF DESCRIPTION OF THE DRAWINGS

FIG. 1 is a front view of an exemplary embodiment of a plasma or ionic gasifier apparatus containing multiple plasma units stacked next to each other to form a reaction chamber.

FIG. 2 is a selectively cross-sectioned top view of a plasma or ionic unit used in the exemplary embodiment of a plasma gasifier apparatus of FIG. 1.

FIG. 3 is a fragmented perspective view of a plasma unit used in the exemplary embodiment of a plasma gasifier apparatus of FIG. 1.

FIG. 4 illustrates a cross-sectional view of an example electrode assembly that may be used within the plasma gasifier of FIG. 1.

FIG. 5 illustrates a first configuration for a tubular support jacket within the electrode assembly of FIG. 4.

FIG. 6 shows a second configuration for a tubular support jacket within the electrode assembly of FIG. 4.

FIG. 7 is a schematic illustrating a plasma module with a hybrid plasma jet and plasma arc system in a vertical configuration.

FIG. 8 is a perspective and partially cut-away view of a hybrid plasma or ionic reactor having a plasma reactor similar to that of FIG. 1 and including a plasma torch disposed vertically at the top of the plasma reactor.

FIG. 9 is a schematic illustrating a plasma module with a hybrid plasma jet and plasma arc system in a lateral configuration.

FIG. 10 is a top view schematic of a plasma unit of the gasifier of FIG. 1, including a first offset electrode arrangement.

FIG. 11 is a top view schematic of a plasma unit of the gasifier of FIG. 1, including a second offset electrode arrangement.

FIG. 12 is a top view schematic of a plasma unit of the gasifier of FIG. 1, including a third offset electrode arrangement.

FIG. 13 is a top view schematic of a plasma unit of the gasifier of FIG. 1, including a fourth offset electrode arrangement.

FIG. 14 is a top view schematic of a plasma unit of the gasifier of FIG. 1, including a fifth offset electrode arrangement.

FIG. 15 depicts a first set of test results for cracking methane using a plasma gasifier with the plasma unit of FIG. 10.

FIG. 16 depicts a second set of test results for cracking methane using a plasma gasifier with the plasma unit of FIG. 10.

FIG. 17 depicts a schematic illustrating a simple plasma module or unit with a single set of arc electrodes which are configured to introduce a working gas having a vortex into a cylindrical reaction chamber.

FIG. 18 depicts a schematic showing a first exemplary embodiment of a plasma arc system in cross-section having groves formed on an outside surface of an arc electrode to induce a vortex in a working gas introduced into a reaction chamber.

FIG. 19 depicts a schematic illustrating a second exemplary embodiment of a plasma arc system in cross-section having groves formed on an inside surface of an arc electrode body to induce a vortex in a working gas introduced into a reaction chamber.

### DETAILED DESCRIPTION

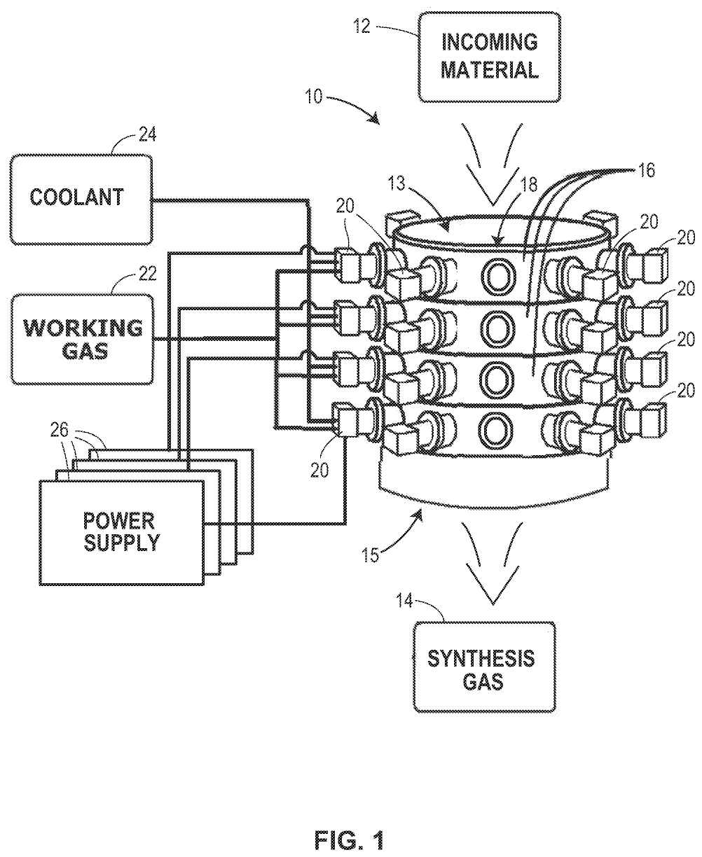

FIGS. 1-3 illustrate a basic plasma or ionic gasifier 10 in which the improvements described herein may be implemented to make the plasma or ionic gasifier 10 more efficient and/or perform better material processing and/or to make the gasifier 10 applicable for the processing of a wide range of materials or uses. Referring to FIG. 1, the plasma or ionic gasifier apparatus 10 processes an input material 12 introduced at an input 13 of the gasifier 10 to produce an output material 14 emitted from an output 15 of the gasifier 10. The output material 14 may be, for example, a synthesis gas and/or other materials as described herein. As illustrated in FIG. 1, the plasma gasifier 10 contains one or more circular plasma units 16 that are stacked in tandem with respect to one another (i.e., aligned along a longitudinal axis through the center of each unit 16), with each plasma unit 16 being formed from a circularly (in cross section) shaped outer ring with a cylindrical interior space defined in the middle of the outer ring. This interior space makes up a plasma or reaction zone 18 within the gasifier 10. Still further, each plasma unit 16 has one or more sets of electrodes 20 extending through the outer wall thereof and into the reaction chamber 18. Each set of electrodes 20 includes an anode electrode and a cathode electrode that extend radially towards the center of the plasma unit 16. Each set of electrodes 20 is coupled to a working gas supply 22, a coolant supply 24 and a power supply 26 by various applicable conducts or electrical connectors. Generally speaking, the working gas supply 22 provides a working gas to each electrode 20, and this gas is transported through and emitted from the electrode, as described in more detail herein, into the reaction chamber 18. This working gas helps cool the electrode tips of the electrodes 20 and, additionally, is subject to high electric fields and arcing created by the electrodes 20 within the reaction chamber 18 and, as a result, ionizes to create plasma within the reaction chamber 18. The coolant supply 24 provides coolant to the electrodes 20 to help assist in keeping the electrodes 20 from overheating during use. This coolant may be recycled and cooled in the coolant supply 24 to create a closed coolant loop. Additionally, the coolant for each electrode assembly 20 may be supplied via a high-pressure pump. After cooling the electrode or an electrode tip as described in more detail herein, the coolant exits the electrode assembly 20 and may be stored in a reservoir, not shown. When fresh water is available, the coolant in the reservoir may be kept cold by a cooling unit, not shown, such as a portable water heat exchanger. In another embodiment, when fresh water is not available, the cooling unit can be a chemical based chiller or any other cooling unit.

Still further, the power supply 26 provides electrical power to the electrodes at sufficient power (e.g., voltage and current) to create arcing between the anode and cathode of each electrode pair 20. The power supply 26 may be an AC power supply which may provide, for example, one phase or three phase AC power to the electrodes 20, or may be a DC power supply. A separate power supply 26 may be provided for each set or pair of electrodes 20 or a combined power supply may provide power to multipole electrode pairs 20. However, the power signal sent to each pair of electrodes 20 may be electrically isolated from the power signals sent to the other pairs or sets of electrodes 20. Still further, the electrode assemblies 20 may be connected to the power supply 26 through water-cooled cables, which provide both the cooling and current paths for the electrode assemblies 20.

Although one plasma unit 16 can be used, performance may be optimized through the use of a plurality of plasma units 16 stacked on top of or next to one another so that the outer walls or rings align longitudinally. For example, in FIG. 1, the plasma gasifier 10 is illustrated as including four stacked plasma units 16 creating an elongated tubular or cylindrical reaction zone 18. It should be understood, however, that the plasma gasifier 10 can have any number or plurality of stacked plasma units 16, including only one. By stacking the plasma units 16, the plasma or reaction zone 18 is lengthened along the longitudinal axis of the gasifier 10, and this elongated space or reaction chamber 18 enables the processing time for the incoming material 12 introduced into the reaction chamber 18 of the plasma gasifier 10 to be extended or increased, as the incoming material 12 flows in sequence through each of the different plasma units 16 when traveling from the input 13 to the output 15 of the gasifier 10. Moreover, the modular configuration created by stacking multiple plasma units 16 next to (e.g., on top of) one another enables an operator to manipulate the power settings in each of the plasma units 16, e.g., in the electrodes 20, separately to achieve an overall temperature profile for the plasma gasifier 10. An operator or designer can also add or subtract modular plasma units 16 to achieve the desired residence time for complete gasification of a particular class of incoming material 12.

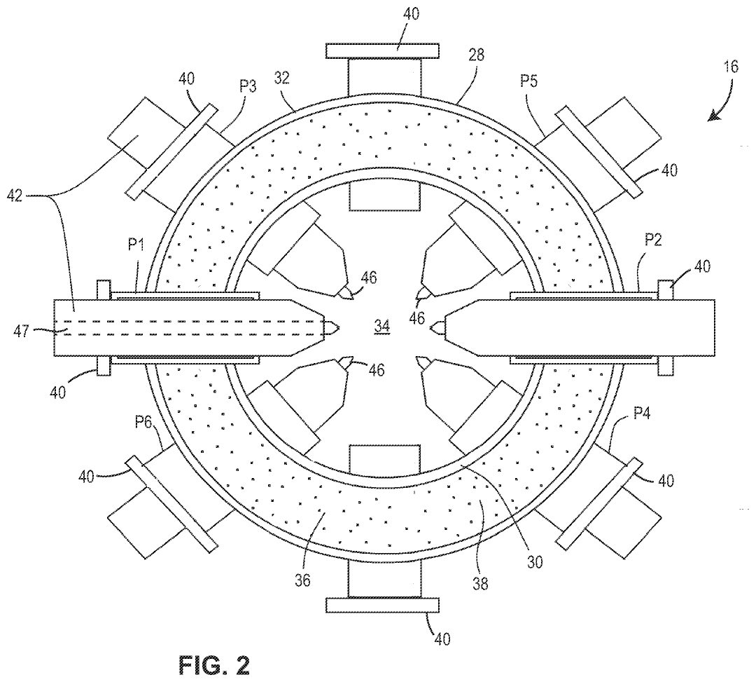

As illustrated more clearly in FIG. 2, which depicts a longitudinal view of one of the plasma units 16 of FIG. 1, each plasma unit 16 has an annular body 28 with an inner wall 30 and an outer wall 32. The inner wall 30 defines a central plasma zone or reaction chamber 34 (e.g., making up part of the reaction chamber 18 of FIG. 1). The inner wall 30 is refractory and so is capable of containing the heat of the plasma without significant degradation. A preferred material for the inner wall 30 is graphite. However, certain refractory ceramics can also be used. A gap space 36 exists between the inner wall 30 and the outer wall 32. The gap space 36 is packed with insulation 38, such as high temperature ceramic fibers. In one embodiment, the insulation 38 (e.g. the ceramic fibers) may be, but is not limited to, Zirconia fibers. Alternatively and/or additionally, granulated sand and/or granulated oxide materials can be used as the insulation 38. Ceramic fibers or granulated oxide materials have significant advantages over conventional solid high-density blocky oxide insulations as granulated oxides and/or ceramic fiber blankets make up very low-density packing materials having significant voids therein. These voids have very low thermal conductivity and have excellent thermal insulation properties. Very low-density thermal insulation materials also reduce the overall weight of the gasifier 10.

In any event, the annular bodies 28 and the central plasma zones 34 concentrically align when the plasma units 16 are stacked. Moreover, the central plasma zone 34 of each plasma unit 16 is accessible through a plurality of access ports 40. Preferably, each plasma unit 16 contains at least eight access ports 40 but any other number of access ports could be used including more or less access ports 40. Each of the access ports 40 is lined with a sleeve of refractory material, such as a ceramic material, that can maintain integrity in the heat field of plasma created in the reaction chamber 34. Moreover, each access port 40 may be used to insert or hold an electrode 42 therein. As such, it is preferable to have at least two access ports 40 in each plasma unit 16 and to provide for an even number of access ports 40, although this is not strictly necessary. Moreover, one or more of the access ports 40 may be used to store or insert a sensor of some sort to provide measurements or viewing of the reactions within the reaction chamber 34.

Most of the access ports 40 in each of the plasma units 16 receive electrodes or electrodes assemblies 42. Each of the electrode assemblies 42 is surrounded by an insulator that is sized to pass into the access ports 40 with tight tolerances. The tolerances prevent any significant gaps from existing between the insulator and the interior of the access port 40 that can leak plasma out of the plasma gasifier 10. As will later be explained in more detail, each of the electrode assemblies 42 includes an electrode tip 46 and a gas conduit 47 (illustrated in dotted relief in one electrode 42 of FIG. 2). The electrode tip 46 extends into the central plasma zone 34 and creates an arc with another electrode tip 46 during operation. The gas conduit 47 introduces a working gas from the working gas supply 22 of FIG. 1 into the plasma or reaction zone 34, which working gas is converted into plasma by the arc created between the tips 46 of two electrodes. Each of the electrode assemblies 42 is cooled by a coolant from the coolant supply 24 of FIG. 1. Moreover, it will be understood that each of the electrode assemblies 42 is coupled to the power supply 26 of FIG. 1 to receive electrical power (voltage and/or current).

Generally speaking, each plasma unit 16 receives the electrode assemblies 42 in sets of two. As such, each plasma unit 16 can receive two, four, six, eight or more of the electrode assemblies 42, depending upon the number of access ports 40 present. The electrodes of a first set of electrode assemblies 42 are set at a first position P1 and a second position P2 on opposite sides of the central plasma zone or reaction chamber 34. Likewise, the electrodes of a second set of electrode assemblies 42 are set at positions P3 and P4 and the electrodes of a third set of electrode assemblies 42 are set at positions P5 and P6. Accordingly, in the example of FIG. 2, there are three sets of electrode assemblies 42 and each of the set of electrode assemblies 42 includes one anode electrode and one cathode electrode. However, any other number of sets of electrode assemblies 42 could be used on each plasma unit 16, including one set, two sets, four sets, etc.

The positions P1, P2 of the first set of electrode assemblies 42 are disposed radially or circumferentially with respect to the positions P3, P4 of the second set of electrode assemblies 42 and with respect to the positions P5, P6 of the third set of electrode assemblies 42 within each plasma unit 16. The angle of separation between the electrode assemblies 42 of the second set and the electrode assemblies 42 of the third set is illustrated in FIGS. 1 and 2 as being 90 degrees. The angle of separation between the electrode assemblies 42 of the first set and the electrode assemblies 42 of the second set is illustrated as 45 degrees. Moreover, the angle of separation between the electrode assemblies 42 of the first set and the third set is also 45 degrees. However, these are but examples and other angles of separation between different sets of electrode assemblies could be used.

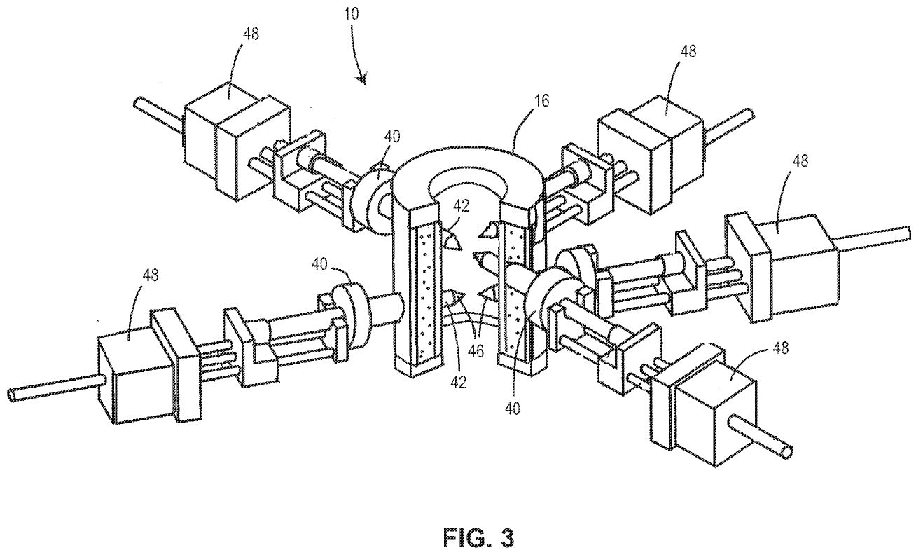

FIG. 3 illustrates one example of the configuration of the electrode assemblies 42 connected to mechanical motivators or actuators for reciprocally moving the electrodes 42 or the electrode tips 46 of the electrodes 42 radially into and out of the reaction chamber 34 while the electrode assemblies 42 are disposed in the access ports 40. The reciprocal movements are controlled by a corresponding linear actuator 48 that attaches to each of the electrode assemblies 42. Each set of electrode assemblies 42 can be moved synchronously to or independent of each other. In a single plasma unit 16, the separation (arc gap) between any set of electrode assemblies 42 can be adjusted by moving those electrode assemblies 42 into, or out of, the access ports 40.

In the exemplary embodiment of FIGS. 1-3, three sets of electrode assemblies 42 are inserted into each plasma unit 16 through the access ports 40. Preferably, in this case, one or both of the remaining access ports 40 are used for observations of the plasma gasifier 10 in operation, such as to hold sensors of some kind or another (e.g., temperature sensors, pressure sensors, video cameras, etc.). Of course, electrode assemblies 42 attach to (are inserted into) the access ports 40 that are not being used for observation. Moreover, as illustrated in FIG. 3, each of the electrode assemblies 42 has the linear actuator 48 that controls the movements of the electrode assemblies 42 into and out of the access ports 40 and each linear actuator 48 may be connected to a control mechanism or controller that enables a user to control the movement of the electrode assemblies 42 during use. The mechanical or linear actuators 48 may be electrical actuators, hydraulic actuators, or any other desired type of mechanical or linear actuators.

During operation, one or more arcs can be ignited between the cathode and the anode of each pair of electrodes by (i) a high voltage discharge, (ii) a high frequency discharge, or by (iii) touching and withdrawing one electrode set from each other. When a high voltage or high frequency discharge is used to ignite an arc, the electrode tips 46 of a set of electrodes 42 are brought in close proximity to each other such as by operation of the actuators 48. After the power supply 26 that supports the electrode assembly 42 in question is energized, a high voltage or high frequency discharge is applied across the central plasma zone 34 between electrode tips 46, which ignites an arc.

In a touch and withdrawal method of igniting an arc, the anode and cathode electrode tips 46 from a particular set of electrode assemblies 42 are brought into contact with each other momentarily after the associated power supply 26 is energized. As soon as a spark is generated, the electrode assemblies 42 are drawn apart quickly and an arc is ignited. Moreover, after a first arc is ignited, a second set of electrode assemblies 42 may be moved into the first arc region for ignition. The second set of electrode assemblies 42 may require thermal conditioning for a few seconds in the arc before it is self-ignited. In particular, thermal conditioning may be required to heat the electrode tips 46 to a sufficient temperature for thermionic emission of electrons to occur. Different plasma units 16 in the same plasma gasifier 10 can be used to form a combined arc system. In this configuration, arc systems complement each other in heating the combined plasma to achieve a much higher energy state than is possible using a single plasma unit 16. Additional plasma units 16 in the plasma gasifier 10 can be ignited in the same way.

As will be understood, the use of a plasma gasifier 10 with two or more plasma units 16 can generate very large and significantly high temperature arcs within the common plasma zone or reaction chamber 34 using relatively low input power from each participating plasma unit 16. Moreover, the plasma units 16 can be duplicated and stacked onto one other. In this manner, when one or more plasma units 16 sustain arcs there is a field free (absence of current and voltage) high-energy plasma tail flame that can flow into other plasma units 16. In this case, the electrode assemblies 42 in the other plasma units 16 superimpose discharges in the tail flame and reignite it back into an arc state so that the stacked plasma units 16 produce a very large plasma column with very significant energy content. The modular stacking configuration of plasma units 16 can operate so that a “field free” (current and voltage free) plasma flame from the upstream unit is reheated to a “field active” (current and voltage active) arc state by superimposing an electric discharge in the downstream plasma units 16. The net plasma energy flow from one plasma unit 16 to another is called “energy cascading,” which adds energy to the downstream plasma units 16 and allows the downstream plasma units 16 to operate with a lower energy requirement.

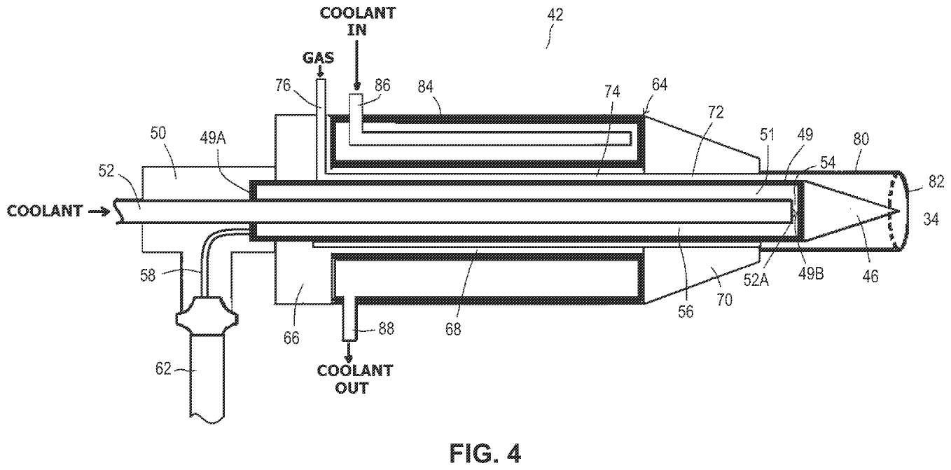

FIG. 4 illustrates an example electrode assembly 42 that may be used in the gasifier 10 described herein. In particular, the electrode assembly 42 includes an electrode tip 46. The electrode tip 46 extends into the central plasma zone or reaction chamber 34 and creates an arc with another electrode tip 46 from a different electrode assembly 42 (not shown in FIG. 4). Each of the electrode assemblies 42 is preferably made of a tungsten, a tungsten alloy, or some other high-temperature conductive material(s). The electrode tip 46 is mounted to the end of a tubular support jacket 49, which is highly conductive and has a first end 49A and an opposite second end 49B. The second end 49B of the tubular support jacket 49 terminates with the electrode tip 46, wherein the electrode tip 46 seals the second end 49B or is directly mounted to a sealed second end 49B. The opposite first end 49A of the tubular support jacket 49 is coupled to an electrode base 50 which is connected to the electrical power supply 26 (FIG. 1), wherein the electrode base 50 receives current from the power supply 26. Any current received at the electrode base 50, travels through the electrode base 50 and into the tubular support jacket 49. The current then flows through the material of the tubular support jacket 49 and into the electrode tip 46.

The tubular support jacket 49 defines an internal compartment or space 51. The coolant from the coolant supply 24 (FIG. 1) is introduced into the internal compartment 51 through a supply tube 52. The supply tube 52 has a dispensing end 52A that terminates in the internal compartment 51 just short of the electrode tip 46. This configuration produces a small gap 54 of, for example, five millimeters between the dispensing end 52A of the supply tube 52 and the electrode tip 46. In this manner, any coolant pumped through the supply tube 52 will impinge directly upon the electrode tip 46, therein directly actively cooling the electrode tip 46.

The supply tube 52 has a smaller outside diameter than the inside diameter of the internal compartment 51. As a consequence, a drain gap 56 exists between the interior of the tubular support jacket 49 and the exterior of the supply tube 52. This drain gap 56 receives the coolant after the coolant is pumped against the electrode tip 46. The draining coolant is directed back into the electrode base 50, which includes one or more conduits 58 that channel the coolant into a coolant outlet. The coolant may surround at least some parts of a power cable 62 that leads from the power supply 26 (FIG. 1). In this manner, the coolant can also actively cool the power cable 62. Thus, the flow of the coolant into and out of the internal compartment 51 of the tubular support jacket 49 directly cools the electrode tip 46 and the tubular support jacket 49 during operation as well as the power cable 62.

An insulator construct 64, which includes an insulation base 66, an elongated insulation tube 68 and a protective insulation cap 70, surrounds the tubular support jacket 49. The insulation cap 70 is annular and defines a central opening 72. The tubular support jacket 49 extends through the central opening 72 in the insulation cap 70, therein supporting the electrode tip 46 just ahead of the insulation cap 70. Because the insulation cap 70 is exposed to the high heat of the central plasma or reaction chamber 34 (FIG. 2), the insulation cap 70 is preferably made of a ceramic material that can withstand the high operating temperatures in this area. The insulation base 66 is also annular and surrounds the tubular support jacket 49 proximate the first end 49A of the tubular support jacket 49. The elongated insulation tube 68 extends around the tubular support jacket 49 between the insulation base 66 and the insulation cap 70. The insulation base 66 and the elongated insulation tube 68 can be fabricated as a single piece, wherein the two elements are molded from tempered glass, ceramic, and/or a high-temperature resistant polymer.

The elongated insulation tube 68 does not contact the inner tubular support jacket 49. Rather, a gap space separates the elongated insulation tube 68 from the tubular support jacket 49, therein forming a gas supply conduit 74. Likewise, the insulation cap 70 does not contact the tubular support jacket 49 so that a gap separates the insulation cap 70 from the tubular support jacket 49, therein continuing the gas supply conduit 74. A gas supply line 76 extends into the insulation base 66 of the insulator construct 64 and connects the working gas supply 22 (FIG. 1) to the gas supply conduit 74. As the working gas flows from the working gas supply 22 into the gas supply line 76, the working gas flows into the gas supply conduit 74 and runs along the length of the tubular support jacket 49 and thereafter flows past the electrode tip 46 into the reaction chamber 34.

As illustrated in FIG. 4, a protective collar 80 is mounted around the electrode tip 46. The protective collar 80 is dielectric and is capable of maintaining integrity in the high temperature environment of the central plasma zone or reaction chamber 34. The protective collar 80 has a first open end that connects to the insulation cap 70 and a second open end 82 at or near the small end of the electrode tip 46. The gas supply conduit 74 extends through the insulation cap 70 and discharges into the protective collar 80 between the protective collar 80 and the electrode tip 46. The working gas flows into the protective collar 80 and is confined around the electrode tip 46, and can only enter the central plasma zone or reaction chamber 34 by flowing past the electrode tip 46, where the electrode tip 46 forms an arc. In this manner, the working gas is turned into plasma by the arc as the working gas enters into the central plasma zone or reaction chamber 34.

A cylindrical casing 84 surrounds most of the elongated insulation tube 68, wherein the cylindrical casing 84 is interposed between the insulation base 66 and the insulation cap 70. The gas supply conduit 74 and the elongated insulation tube 68 separate the cylindrical casing 84 from the tubular support jacket 49. The cylindrical casing 84 is made of a highly thermally conductive material and is hollow. The interior of the cylindrical casing 84 is cooled with a flow of coolant that flows through the cylindrical casing 84 from an input port 86 to an output port 88. The cylindrical casing 84 therefore acts as an actively cooled heat sink, which absorbs heat directly from the insulation cap 70. The cylindrical casing 84 also absorbs heat passing through the elongated insulation tube 68. Lastly, the cylindrical casing 84 absorbs heat from the insulation base 66. It will therefore be understood that, during operation, the tubular support jacket 49 is internally cooled by the coolant flowing within the internal compartment 51 and externally cooled by the coolant flowing through the cylindrical casing 84. Additionally, the working gas flowing in the gas supply conduit 74 cools the tubular support jacket 49 which, in turn, cools the electrode tip 46. This active cooling reduces over-heating of the electrode tip 46 and prevents excessive consumption and erosion of the electrode tip 46. Furthermore, the high electrical conductivity of the tubular support jacket 49 reduces junction resistive heating, which allows high joule heating to occur at the electrode tip 46 for better thermionic emission of electrons that form and sustain an arc. Of course, the electrode assembly 42 illustrated and described with respect to FIG. 4 is one example of an electrode assembly that may be used to provide power, coolant and a working gas to an electrode used in the gasifier 10 of FIG. 1, and other electrode assembles could be used instead or in addition. For example, an electrode assembly illustrated in and described with respect to FIG. 4 of U.S. Pat. No. 10,208,263, which is hereby expressly incorporated by reference herein, could be used instead.

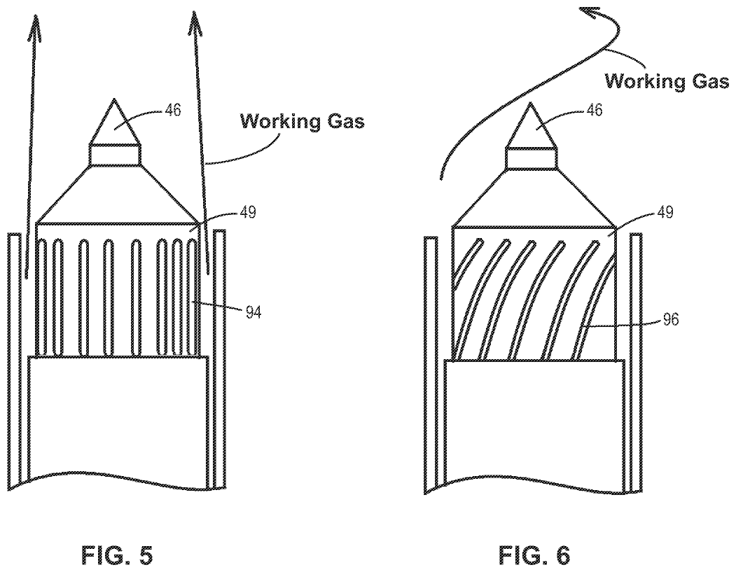

As previously stated, the working gas exiting the gas supply conduit 74 of FIG. 4 is ejected in a circle around the electrode tip 46. However, the generation of plasma or ionic gas is most effective when the working gas exiting around the electrode tip 46 does not disperse away from any arc that is emanating from the electrode tip 46. One way to help ensure that the working gas remains in a tight stream is to eject the working gas in a directed laminar flow, rather than a random turbulent flow. Referring to FIGS. 5 and 6, it will be understood that a laminar flow profile can be induced in the working gas by providing flow channels in the exterior of the tubular support jacket 49. FIG. 5 illustrates straight flow channels 94. FIG. 6 illustrates spiral or swirl flow channels 96. As the working gas flows over the flow channels 94, 96, the working gas is provided with a directed flow, be it straight or spiral. This directed flow tends to be laminar or swirl for typical flow rates being used. Moreover, the directed flow of the working gas through the flow channels 94, 96 has other unique performance characteristics. In particular, the tubular support jacket 49 may be made of a copper alloy that has a much better thermal conductivity than does the tungsten alloy of the electrode tip 46. In this case, the tubular support jacket 49 acts a heat sink to the electrode tip 46. As the working gas flows through the flow channels 94, 96, the working gas cools the tubular support jacket 49 which, in turn, cools the electrode tip 46. This configuration reduces over-heating of the electrode tip 46 and helps to prevent excessive consumption and erosion of the electrode tip 46. Furthermore, the high electrical conductivity of the tubular support jacket 49 reduces junction resistive heating within the electrode tip 46, which allows high joule heating to occur at the electrode tip 46 for better thermionic emission of electrons that form and sustain an arc.

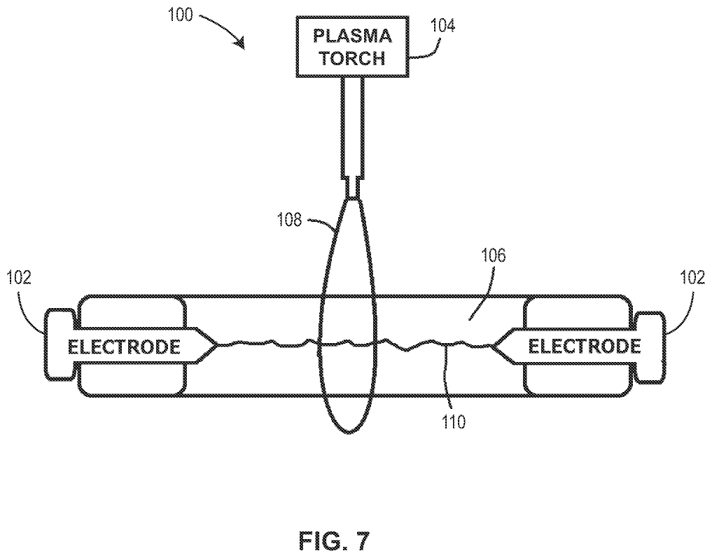

FIGS. 7-9 illustrate a hybrid gasifier system 100 that includes both a set of plasma arc electrodes 102 and one or more plasma torches 104 disposed adjacent a reaction chamber 106 in a manner that creates and introduces plasma or ionic material into the reaction chamber 106 as well as producing electrical arcing within the reaction chamber 106 to provide for enhanced materials processing, such as waste-to-energy conversion, wastewater destruction, nano-material synthesis, and methane cracking to produce hydrogen, to name but a few. In particular, the hybrid gasifier system 100 of FIG. 7 includes the plasma torch 104 disposed in a vertical configuration with respect to the arc electrodes 102. As such, the plasma torch 104 is positioned vertically with respect to (e.g., above) the plasma or reaction chamber 106. Of course, more than one plasma torch 16 could be used depending upon the size of the plasma or reaction chamber 106, and the plasma torch 104 could be disposed at other locations with respect to the arc electrodes 102, such as below the electrodes 102 in the embodiment of FIG. 7 with the plume 108 pointing upward. In any case, the plasma torch 104 is disposed to inject plasma or ionic material into the chamber 106 in a direction that is orthogonal to, e.g., perpendicular to, the direction of the arcing and or working gas introduced into or created in the reaction chamber 106 by the arc electrodes 102. As will be understood, the plasma torch 104 of FIG. 7 creates a plasma jet 108 which emanates from the plasma torch 104 and fires downwardly (or upwardly) in a vertical path through the center of the plasma or reaction chamber 106 and which may interact with or cross one or more arcs 110 within the reaction chamber 106 formed between the electrodes 102.

Of course more than one set of arc electrodes 102 can be positioned within the system of FIG. 7. For example, between one and four sets of arc electrodes 102 can be used although more sets could be used as well. Additionally, these arc electrodes 102 can be any of the electrodes described herein with respect to FIGS. 1-6. In this example, the arc electrodes 102 are placed in lateral configurations to create free expanding arcs 110 in the plasma or reaction chamber 106. The free expanding arcs 110 interlink with the vertical plasma jet 108 from the plasma torch 104 and together the plasma (created by both the arc electrodes 102 and the plasma torch 104) and electrical arcs (created by the arc electrodes 102) provide for enhanced heating of and processing of the materials introduced into the reaction chamber 106 via an input (not shown in FIG. 7).

More specifically, each set of arc electrodes 102 includes an anode electrode and a cathode electrode. The free expanding arc 110 created across the plasma or reaction chamber 106 between the anode electrode and the cathode electrode of the various different sets of arc electrodes 102 interacts with the plasma jet 108 that is passing through the center of the plasma or reaction chamber 106 to provide a strong ionization source for creating ionized material (e.g., gas) in the reaction chamber 106. This ionization facilitates ignition and sustainment of the free expanding arcs 110 created by the various different sets of arc electrodes 102. The free expanding arcs 110, in turn, create an electrical field in the plasma or reaction chamber 106. Due to the presence of the electric field, part of the plasma jet 108 becomes an active arc and increases the temperature of that portion of the plasma jet. The free expanding arcs 110 can therefore form without a supply of electrode working gas. However, a variety of working gas(es) can be supplied to and be emitted from the arc electrodes 102 to form the free expanding arcs 110 using electrode configurations as described in FIG. 4. The hybrid plasma jet and plasma arc system 100 produces a uniform and highly energetic large volume plasma field to enable a high temperature environment for waste-to-energy conversion, hazardous solid waste and wastewater destruction, nano-materials synthesis, methane cracking to produce hydrogen, and other plasma processing applications.

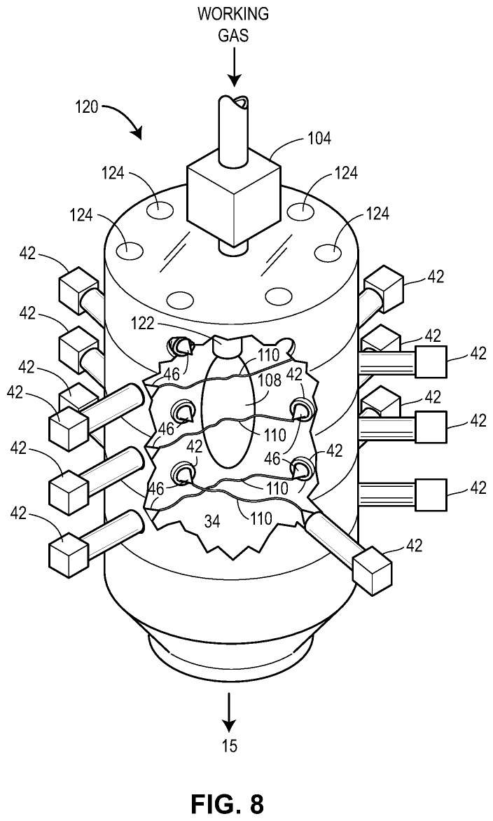

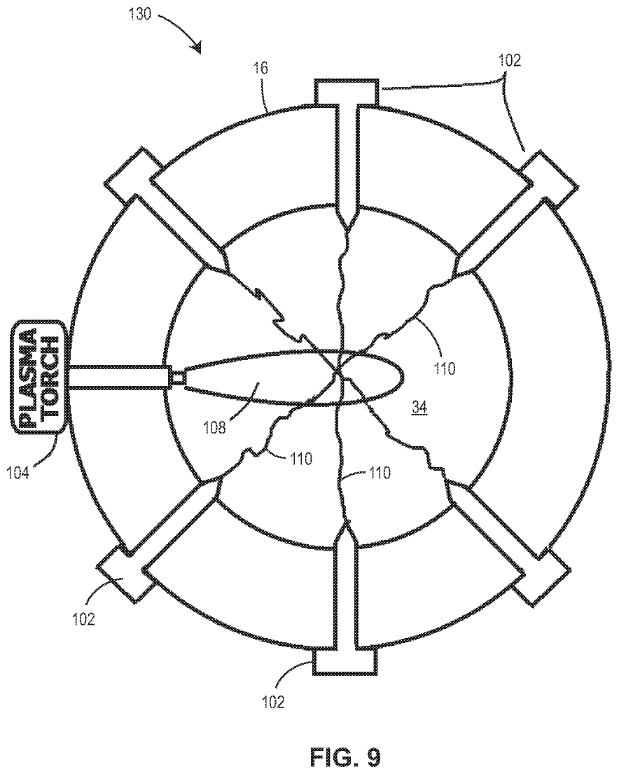

FIG. 8 depicts a perspective, partially cut-away view of a hybrid gasifier 120 implementing the vertical plasma torch configuration of FIG. 7. The hybrid gasifier 120 is essentially the gasifier 10 of FIG. 1 modified to include the vertically mounted plasma torch 104 of FIG. 7. The same or similar reference numbers are used in FIG. 8 as are used in FIGS. 1-7 to indicate the same or similar components. As illustrated in FIG. 8, the hybrid gasifier 120 includes multiple plasma units 16 stacked vertically on top of one another with electrode assembles 20 (FIG. 1) or 42 (FIGS. 2-6) mounted in the ports 40 (as shown in FIGS. 2-3) so that the anode and the cathode of a particular set of electrode assemblies 42 are disposed on opposite sides of the unit 16, i.e., 180 degrees around the unit 16 in which the electrodes are disposed, and so that the electrodes 42 extend radially into the reaction chamber 34. While the hybrid gasifier 120 of FIG. 8 is illustrated as including three plasma units 16 each with three sets of electrodes 42, more or less plasma units 16 could be used and more or less sets of electrodes 42 could be disposed in each plasma unit 16. Still further, while the sets of electrodes in adjacent plasma units 16 are illustrated as being mounted in a vertical line with respect to one another, the various electrodes 42 of different plasma units 16 could be offset from the electrodes in adjacent plasma units 16 by any desired angle (e.g., by 15 degrees, 20 degrees, 30 degrees, etc.).

Likewise, as illustrated in FIG. 8, a plasma torch 104 is mounted on the top of the hybrid gasifier 120 and has an output 122 that extends into or that is disposed at the top of the reaction chamber 34 above or higher than the uppermost plasma unit 16. The plasma torch 104 is connected to a source of working gas and receives the working gas. As is typical, the plasma torch 104 (also referred to as a plasma jet reactor), creates or generates an arc between a cathode electrode and an anode electrode that are positioned close together inside the body of the torch 104 (not shown in FIG. 8). The working gas is then passed through the arc, therein creating a tongue of plasma which is then emitted from the output 122 of the plasma torch 104 as a stream of hot plasma 108 into a reaction chamber 34. Here, depending on the flow of the working gas into the plasma torch 104, the stream of hot plasma 108 may travel down through the center of the reaction chamber 34 (i.e., longitudinally with respect to a longitudinal axis of the plasma units 16) and intersect the reaction zones of one or more of the plasma units 16, thereby providing additional plasma or ionic material in the reaction chamber 34 to process material therein.

As illustrated in FIG. 8, the material to be processed may be introduced into the reaction chamber 34 via one or more openings or inputs 124 disposed in the top of the gasifier 120 around or near the plasma torch 104. However, the processing material input(s) 124 of the hybrid gasifier 120 may be located at one or more other locations on the gasifier 120, such as on the side of the gasifier 120 above the first (uppermost) plasma unit 16. The material to be processed, once introduced via an input 124, is gravity fed and flows down through the reaction chamber 34 through each of the stacked plasma units 16. Of course, this material contacts or interacts with the ionic gas produced by the plasma torch 104, especially near the inputs 124, and also interacts with the electrical arcs (shown in some cases in FIG. 8) that emanate from or that form between the electrode tips of the anode and cathode electrodes of the various pairs of electrode assemblies 42 extending into the reaction chamber 34. In the case in which the electrode assemblies 42 also provide a working gas within the chamber 34, which also becomes ionized (i.e., forms plasma), the material to be processed additionally interacts with this plasma, all of which helps heat and break down the material. Thus, as will be understood, the plasma from the plasma torch 104 provides additional heating and ionized gases which interact with and break down the material being processed. Likewise, the plasma stream 108 generated by the plasma torch 104 may be used to ignite one or more of the sets of electrodes 42 during start up by providing plasma and heat in the chamber 42. This operation may reduce or eliminate the need to cause the anode and cathode electrodes of a pair of electrode assemblies to be moved together or to touch to start the arcing activity. This operation may also reduce or eliminate the need to provide working gas into the reaction chamber 34 via the electrodes 42. In any event, after the material being processed travels generally vertically through (from top to bottom) the reaction chamber 34 and is subjected to the plasma generated by the plasma torch 104 and the plasma and arcs generated by the various pairs of electrode assemblies 42 in each of the plasma units 16, the processed material leaves the reaction chamber 34 via one or more outputs 15 at the bottom (lower vertical end) of the gasifier 120. While the plasma torch 104 is illustrated in FIG. 8 as being disposed near the inputs 123, it could be disposed near the output 15 and extend longitudinally into the reaction chamber 34 from the bottom, expelling or emitting plasma (e.g., a plasma plume or flame) directed upwards through the center of the reaction chamber 34.

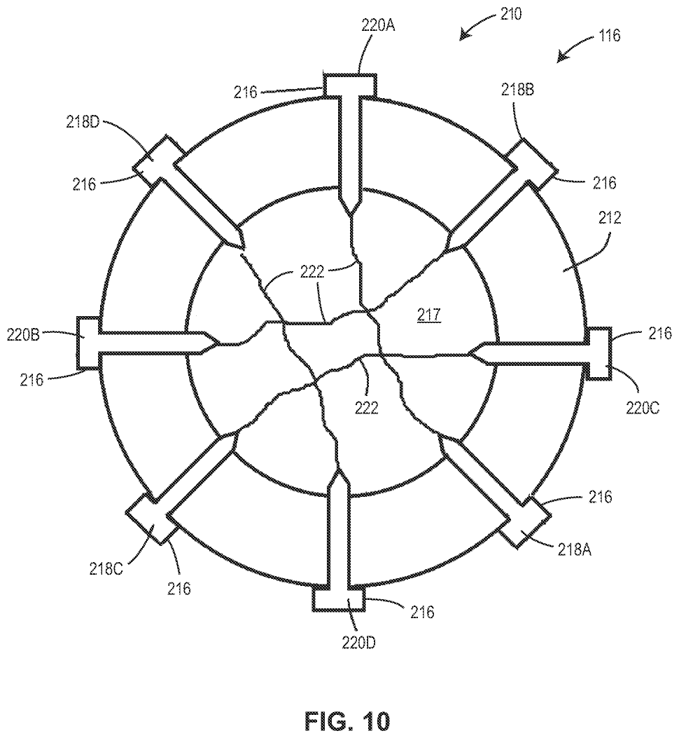

As another example of a hybrid gasifier, FIG. 9 depicts a simple schematic view of a gasifier 130 having a lateral configuration in which one or more plasma torches 104 are placed in lateral positions around the outer wall of the plasma unit 16 and are interspersed with arc electrodes 102 which are also mounted to the plasma unit 16 as previously described herein. The plasma torch 104 creates a plasma jet 108 that fires laterally (radially) into and towards the center of the plasma or reaction chamber 34, while the arc electrodes 102 produce free expanding arcs 110. The plasma jet 104 may operate to ignite the free expanding arcs 110 and additionally travels into the center of the plasma unit 16 to provide a strong ionization source in the plasma chamber 34. This ionization facilitates ignition and sustainment of the free expanding arcs 110 which, in turn, create an electric field. Due to the presence of the electric field in the plasma chamber 34, a portion of the plasma jet 108 becomes an active arc and increases the temperature of that portion of the plasma jet. The free expanding arcs 110 can, in this case, form without a supply of electrode working gas. Alternatively, a variety of working gas(es) can be supplied to the arc electrodes 102 in the manners described herein to ignite the free expanding arcs 110 and provide additional ionization material within the chamber 34. It will be understood that the lateral configuration illustrated in FIG. 9 may be obtained, in one example, by mounting one or more plasma torches 104 into one or more of the unused ports 40 of FIG. 2. Moreover, while only a single plasma torch 104 is illustrated in the embodiment of FIG. 9, multiple different plasma torches may be mounted in a single plasma unit 16 and/or multiple different plasma torches 104 may be mounted in different ones of the stacked plasma units 16 of, for example, FIG. 1.

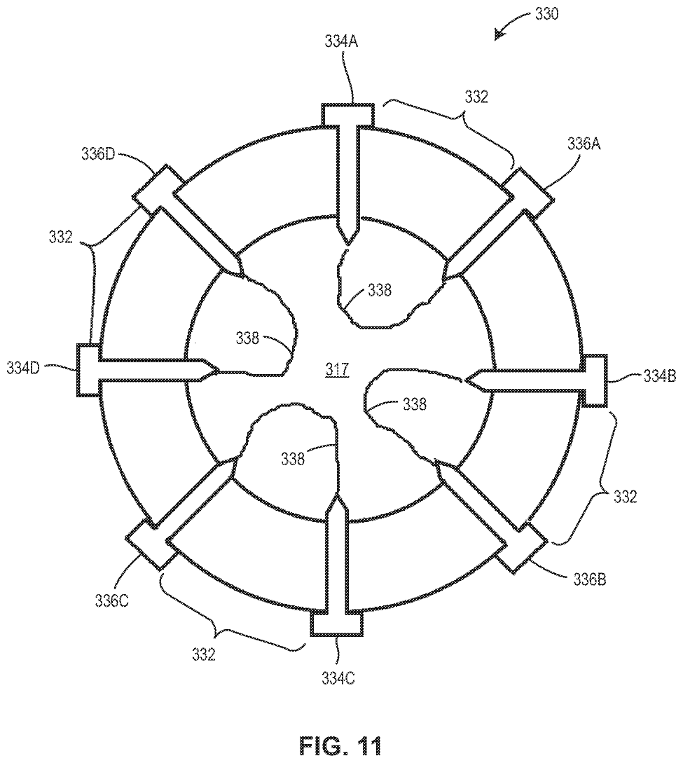

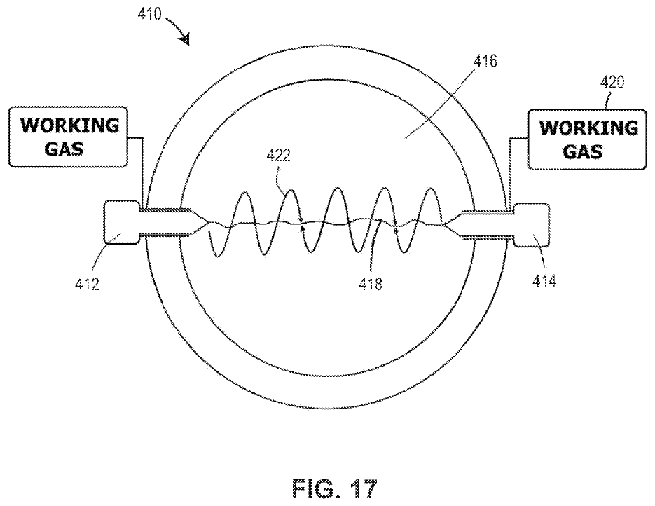

Both the vertical hybrid configuration of FIGS. 7 and 8, and the lateral hybrid configuration of FIG. 9 produce uniform and highly energetic large volume plasma fields to enable a high temperature environment for waste-to-energy conversion, hazardous solid waste and wastewater destruction, nano-materials synthesis, methane cracking to produce hydrogen, and other plasma processing applications. Moreover, both of these types of plasma torch placement configurations can be implemented in a hybrid gasifier having any of the electrode configurations, spacings and placements described herein, including any of the offset electrode configurations (e.g., FIGS. 10-14), non-offset electrode configurations, and gas vortex induction configurations (e.g., FIGS. 17-19) described in more detail herein.

It will be noted that in each of the embodiments described above, each set of arc electrodes 20, 42, 102, 104 is disposed around the plasma unit 16 and is directed inwardly in a radial direction, with the anode electrode and the cathode electrode of each set or pair of electrodes being disposed on the opposite side of the plasma unit 16, such that these two electrodes are offset 180 degrees apart from one another circumferentially around the plasma unit 16. As a result, the arc traveling between these electrodes passes through the center of the reaction chamber 34. Of course, when two or more sets of electrodes are so disposed around a plasma unit 16, the arcs from each of these sets of electrodes pass through the center (or very close to the center) of the reaction chamber 34. These multiple arcs at or near the center of the reaction chamber 34 produce a very hot area near the center of the chamber 34 which provides for significant processing of material at the center of the chamber. This feature can be beneficial in some instances. However, this configuration can result in less plasma and arc processing and/or heat in other areas of the reaction chamber 34 not at the center. It may be beneficial to cause the arcs from different ones of the sets of electrodes to follow one or more paths that do not go through the center of the chamber, thereby disbursing the arcs and plasma generation more evenly throughout the reaction chamber 34. This feature then leads to more even processing of material within the chamber 34, no matter whether the material travels through the chamber 34 at the center or off center of the chamber 34.

Thus, in one embodiment, an improved plasma or ionic reactor described herein uses multiple sets of opposed arc electrodes disposed around a reaction chamber in a manner that operates to disburse the arcs from multiple sets of electrodes over a larger area of the reaction or plasma chamber 34, thereby effectively increasing the size of the reaction zone in which at least one arc are present. This feature then produces more areas within a plasma or reaction chamber at which at least one arc is present, which increases the temperature profile across the entire horizontal or lateral cross section of the reaction. In particular, to change the arcing profile within the reaction chamber to be more even across the reaction chamber, the anodes and cathodes of various pairs of electrodes are disposed at circumferential angles other than 180 degrees with respect to one another around the outer wall of the reaction chamber, so that the anode and cathode of a particular pair of electrodes are disposed at an acute angle (less than 90 degrees) or an obtuse (between 90 and 180 degrees) angle or at 90 degrees with respect to one other. Moreover, the anodes and cathodes of different sets of electrodes are juxtaposed with each other around the chamber to intersperse the polarity of adjacent electrodes. As a result, some or all of the arcs produced by the electrodes do not necessarily travel directly through the center of the reaction chamber but traverse the chamber offset from the center of the chamber. In this manner, arcs produced by different sets of electrodes travel through the reaction chamber on various different paths through the chamber, thereby better distributing the arcs throughout the reaction chamber. The disbursal of arcs more evenly throughout the reaction chamber provides for better or more even processing of the material flowing through the chamber and enables the chamber to be used for new purposes, such as producing carbon nanoparticles.

As an example, FIG. 10 illustrates a first offset electrode configuration that may be used to provide for better arc coverage in a reaction chamber. In particular, FIG. 10 illustrates a longitudinal or top inner view of a gasifier 210 having a plasma unit 212, which may be, for example, one of the plasma units 16 of FIG. 1. In this case, the plasma unit 212 includes four pairs of arc electrodes 216 disposed therein and the wall of the plasma unit 212 defines a plasma chamber 217. Moreover, the sets or pairs of arc electrodes 216 are set into the wall of the plasma unit 212 and are installed such that each set of arc electrodes 216 includes a cathode electrode 218 and an anode electrode 220.

To achieve and maintain better plasma arc symmetry and stability, the sets of arc electrodes 216 are arranged in an alternating polarity configuration so that each cathode electrode is circumferentially disposed between two anode electrodes and each anode electrode is circumferentially disposed between two cathode electrodes. As such, the electrodes 216 alternate in polarity as they go around the circumference of the plasma unit 112. In the illustrated embodiment, the plasma module 212 has four sets of arc electrodes 216, which provides eight total electrodes with four cathode electrodes 218A, 218B, 218C, 218D and four anode electrodes 220A, 220B, 220C, 220D. The electrodes 216 are disposed evenly around the wall of the unit 212 and so are separated from their nearest neighbor by an angle of 45 degrees. Moreover, the two electrodes (anode and cathode) within a set of arc electrodes 216 are arranged at a particular obtuse angle in relation to one another, with this angle being 135 degrees in the system of FIG. 10. Thus, the placement of the arc electrodes 216 embody a specific directional rotation to achieve a complete alternating electrode polarity for the eight electrodes. This arrangement of alternating electrode polarity produces a plasma arc system or unit 210 with very stable arc formations and a more uniform high temperature plasma field.

As illustrated in FIG. 10, the four sets of arc electrodes 216 create four arcs 222 in the plasma chamber 217. An “A” set of arc electrodes 216 has a first anode electrode 220A located at the 0 degree or top position (in FIG. 10) and the associated first cathode electrode 218A is offset clockwise by an obtuse angle of 135 degrees from the first anode electrode 220A. As will be understood, the electrodes 218A and 220A are powered by the same power supply.

Moreover, a “B” set of arc electrodes 216 includes the cathode electrode 218B and an anode electrode 220B. The cathode electrode 218B is disposed adjacent to, and is offset by 45 degrees (in the clockwise direction) from the first anode electrode 220A. However, the second anode electrode 220B is offset by 135 degrees in the counterclockwise direction from the second cathode electrode 218B. Additionally, the electrodes 218B and 220B are powered by the same power supply which may be a different power supply than the power supply providing power to the “A” set of electrodes 218A, 220A.

Still further, a “C” set of arc electrodes 216 includes the cathode electrode 218C and an anode electrode 220C. The third anode electrode 220C is adjacent to and between the second cathode electrode 218B and the first cathode electrode 218A, is offset clockwise by 90 degrees from the first anode electrode 220A and is offset by 135 degrees in the clockwise direction from the third cathode electrode 218C. Additionally, the electrodes 218C and 220C are powered by the same power supply, which may be a different power supply than the power supply providing power to the “A” set of electrodes 218A, 220A and/or to the “B” set of electrodes 218B, 220B.

Finally a “D” set of arc electrodes 216, includes a cathode electrode 218D and an anode electrode 220D. The fourth cathode electrode 218D is disposed adjacent to and between the first anode electrode 220A and the second anode electrode 220B. Likewise, the fourth cathode electrode 218D is offset by 180 degrees from the first cathode electrode 218A, and is offset by 135 degrees in the counterclockwise direction from the fourth anode electrode 220D. Additionally, the electrodes 218D and 220D are powered by the same power supply, which may be a different power supply than the power supply providing power to the “A” set of electrodes 218A, 220A, and/or to the “B” set of electrodes 218B, 220B, and/or to the “C” set of electrodes 218C, 220C.

In this configuration, the anode electrodes 220A and 220D are disposed directly opposite from each other in a first orthogonal axis and the anode electrodes 220B and 220C are disposed directly opposite from each other in a second orthogonal axis. Similarly, the cathode electrodes 218A and 218D are disposed directly opposite from each other in a third orthogonal axis and the cathode electrodes 218B and 218C are disposed directly opposite from each other in the remaining orthogonal axis. This arrangement achieves an alternating electrode polarity for all adjacent electrodes and provides a very stable arc configuration with a very large and uniform high temperature plasma field for materials processing within the chamber 217. In particular, the arcs 222 produced by the different sets of electrodes 216 cross each other and join near, but not directly at, the center of the plasma chamber 217 resulting in a larger arc field in the chamber 217 in which the arcs 222 do not all pass through the same point in the chamber 217 (i.e., the center point). Moreover, the arcs 222 behave like a single arc in the middle of the plasma chamber 217, so that the joint heating power in the center of the chamber 217 is substantially higher than sum of all the heating power of each individual arcs 222.

Referring to FIG. 11, an alternate plasma arc system or unit 230 is illustrated. In this plasma arc system 230, there are four sets of arc electrodes 332 marked as an A set, a B set, a C set and a D set. Here, each set of electrodes is powered separately by, for example, a different power supply. Each of the sets of electrodes 332 has an anode electrode 334 (334A, 334B, etc.) and a cathode electrode 336 (336A, 336B, etc.) and, for each set of arc electrodes 332, the anode electrode 334(A-D) is positioned adjacent to the associated cathode electrode 336 (A-D) with a 45 degree angle of separation (circumferentially). This electrode configuration achieves alternating electrode polarity with the anode electrode 334 and cathode electrode 336 of an associated set of electrodes 332 being disposed in a manner that is not directly opposite (i.e., 180 degrees) around the unit 330. In this configuration, each anode electrode 334 is disposed directly opposite from another anode electrode 334 in one or more orthogonal axes while each cathode electrode 336 is disposed directly opposite from another cathode electrode 336 one or more other bisecting orthogonal axes. This arrangement achieves an alternating electrode polarity for all adjacent electrodes and, as a result, as illustrated in FIG. 11, the sets of arc electrodes 332 produce arcs 338 that do not necessarily cross each other. However, in some cases, each arc 338 may have a small portion of the arc body that overlaps near the center of the plasma chamber 317. This partial overlap of arcs 338 behaves like a small additional arc in the middle of the plasma arc system 330. The heating power of the combined partial arc currents in the center supplements the heating power of each individual arc 338 in the plasma arc system 330 and forms a uniform high temperature plasma for materials processing.

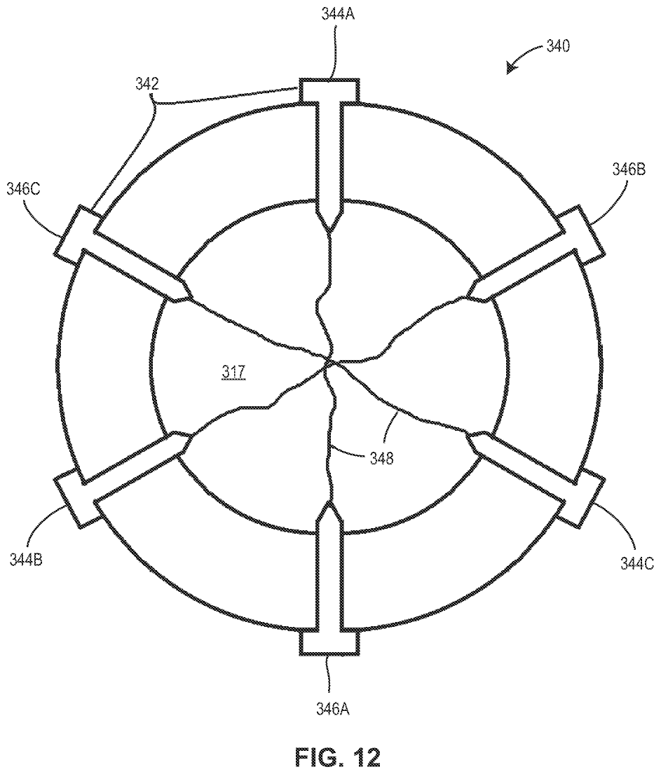

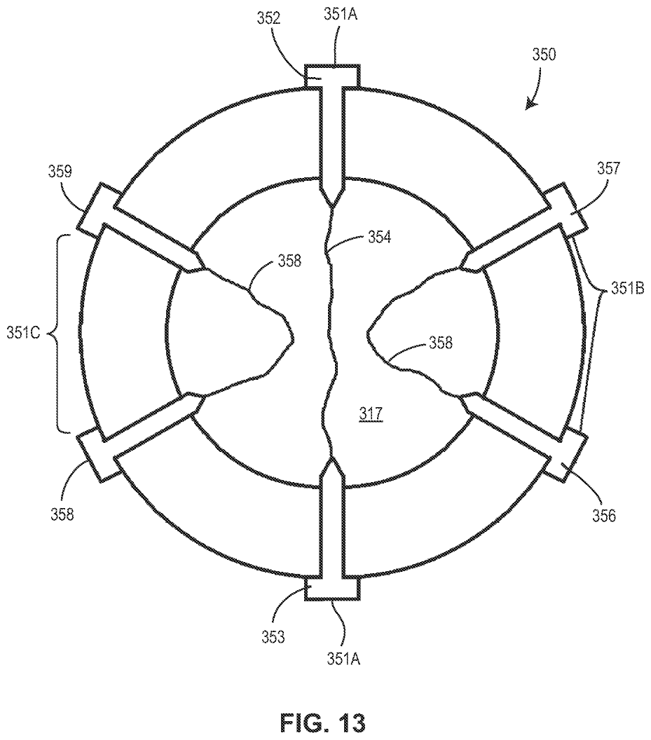

FIGS. 12-14 illustrate three alternative plasma arc systems or units 340, 350, 360. In each embodiment, anode electrodes and cathode electrodes are arranged to achieve alternating electrode polarity that provides the systems 340, 350, 360 with very stable arc formations and uniform high temperature plasma fields.

Referring to FIG. 12, there are three sets of arc electrodes 342 (labeled as A, B and C sets of electrodes) with the anode electrodes 344 and the cathode electrodes 346 of each set being arranged 180 degrees apart. Every anode electrode 344 is disposed adjacent to and between a cathode electrode 346 to the left and to the right. Arcs 348 are produced by the sets of arc electrodes 342 and arcs 348 join or cross at the center of the plasma chamber 317. Moreover, a portion of the joined arcs 348 behaves like a single arc. The heating power of this joined arc region is much higher than the peripheral arc regions.

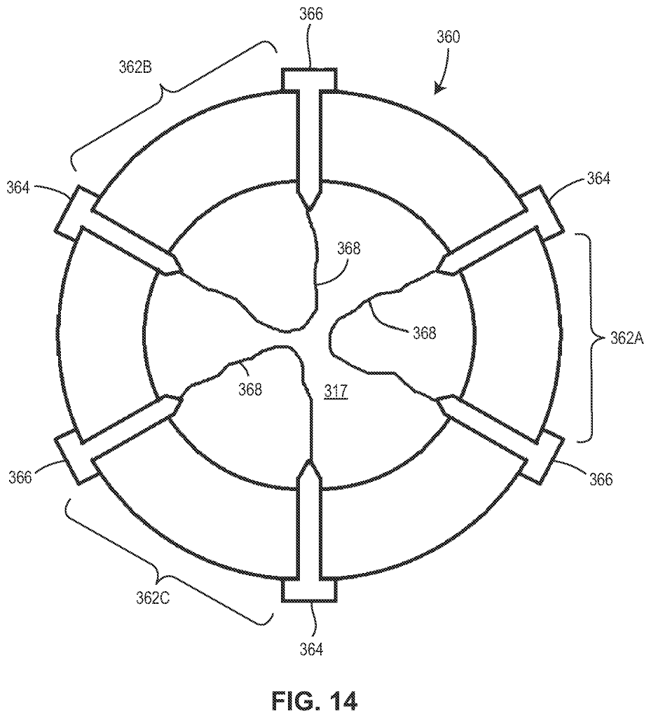

FIG. 13 illustrates another asymmetric arrangement of sets of arc electrodes in a plasma unit 350 that includes three sets of electrodes, 351A, 351B, 351C disposed around the unit 350. Each of the sets of electrodes 351A, 351B, and 351C may be powered by a separate power supply. The first set of arc electrodes 351A includes an anode electrode 352 and a cathode electrode 353 arranged 180 degrees apart on (i.e., on opposite sides of) the unit 350. This first set of arc electrodes 351A produces a straight arc 354 that travels through the center of the chamber 317. The second set of arc electrodes 351B has an anode electrode 356 and a cathode electrode 357 that are offset by 60 degrees, while the third set of arc electrodes 351C has an anode electrode 358 and a cathode electrode 359 that are offset by 60 degrees. Moreover, the anode electrodes 352, 356 and 358 are each disposed adjacent to, and are disposed 60 degrees apart from two of the cathode electrodes 353, 357 and 359, so that the unit 350 has interspersed or alternating anode and cathode electrodes when going around the unit 350. Moreover, the 60 degree offset positions of the anodes and the cathodes of the sets of arc electrodes 351B and 351C place these sets of electrodes across the unit 350 from each other and produces secondary arcs 358 that are divided by the straight arc 354. The result is partial arc mixing at the center of the plasma module, which produces a central heating power higher than the peripheral arc regions while still providing arc creation over a wider cross section of the unit 350.

FIG. 14 illustrates a plasma unit 360 having three sets of arc electrodes 362A, 362B and 362C, each having an anode electrode 364 and a cathode electrode 366 that are arranged 60 degrees apart. This configuration is very similar to the four set of electrode configuration illustrated in FIG. 11. In this configuration, there will be partial mixing and joining of arcs 368 at the center of the plasma chamber 317. The partial mixing and joining of the arcs 368 produces a joint heating power that is higher than the peripheral arc regions. In these configurations, all plasma electrodes 364, 366 can be positioned to achieve alternating electrode polarity thus increasing arc stability.

Of course, while various different arc electrode placements are illustrated and described with respect to FIGS. 10-14, it will be noted that, for each of these configurations, the arcs produced in the plasma chamber reinforce one another and these arrangements all include alternating electrode polarity for all adjacent electrodes. This aspect of the illustrated configurations provides for a very stable arc configuration and a very large and uniform high temperature plasma field for materials processing. Moreover, in some cases, some or all of the arcs may cross each other and in other cases none of the arcs cross each other. Still further, with these various configurations, no arcs, one arc, a plurality of the arcs less than all of the arcs or all of the arcs may cross through the center of the reaction chamber. Still further, the arcs may cross each other or not cross each other but may join near the center of the plasma chamber and behave like a single arc in the middle of the plasma unit. As such, the joint heating power in the center of the reaction chamber may be substantially higher than the sum of all the heating power of each of the individual arcs while still providing for the arcs to be spread out throughout the cross section of the chamber in a more even or distributed manner. The temperature at or near the center region of the reaction chamber is expected to be near or at least 3000K and even up to 5000K, and this temperature can cause the complete disintegration of feed materials.

Of course, other arc electrode placement configurations can be used instead of those specifically described and shown herein. For example, while the embodiments of FIGS. 10-14 illustrate configurations with three and four sets of electrodes, other embodiments could include two sets of electrodes or more than four sets of electrodes. Still further, while it is desirable to interspace the sets of electrodes such that anode electrodes and the cathode electrodes are interspersed with or adjacent one another around the entire plasma unit, this feature may not be critical and so, in some cases, two anode electrodes and/or two cathode electrodes may be placed adjacent to one another while interspersing other ones of the anode and cathode electrodes. Likewise, all of the electrodes illustrated in FIGS. 10-14 are equally separated around the plasma, by an angle that is calculated as 360 divided by the total number of electrodes. However, in some cases, the electrodes do not need to be evenly spaced around the perimeter of the plasma unit and so some adjacent electrodes could be separated by a first angle and other adjacent electrodes could be separated by other angles greater than or less than the first angle. Moreover, the anode and cathode electrodes of a particular pair of electrodes can be separated by any desired angle around the perimeter of the unit, such as at an acute angle, at 90 degrees, at an obtuse angle or at 180 degrees. While the embodiments of FIGS. 10-14 illustrate various different anodes and cathodes of an electrode pair being separated by 45, 60, 90, 135 and 180 degrees, other angles could be used instead (and these angles may be dependent on or effected by total number of electrodes). Still further, different pairs of electrodes in the same unit may have their respective anode and cathode electrodes separated by different angles. Thus, as illustrated in FIG. 13, one pair of electrodes has the respective anode and cathode electrodes separated by 180 degrees while other pairs of the electrodes have their respective anode and cathode electrodes separated by 60 degrees. Of course other combinations of electrode separations could be used instead or in addition to those described and illustrated herein. Likewise, various different combinations of electrode spacings or offsets can be used so that, in some cases, none of the arcs produced by the various sets of electrodes cross each other, in other cases each arc produced by each set of electrodes crosses every other arc produced by the other sets of electrodes, and in other cases an arc produced by one or more of set of electrodes may cross one or more of the arcs produced by the other sets of electrodes but not all of the arcs produced by the other sets of electrodes. Still further, in many cases, the arcs produced by a set of electrodes will not be aligned with (e.g. pass through) the center of the reaction chamber due to the anode electrode and the cathode electrode of the set of electrodes being spaced apart at an angle other than 180 degrees.

In any event, the arcing environment achieved by the embodiments described in FIGS. 10-14 is particularly useful for producing carbon nano-particles, such as carbon nano-onions and for methane cracking. More particularly, carbon nano-onions (CNOs) are known as multi-shell fullerenes and were discovered in 1992. Carbon nano-onions are structured concentric shells of carbon atoms. Over the years, different methods for the synthesis of carbon nano-onions have been developed and studied. In addition, the chemical functionalization of carbon nano-onions has been investigated and several synthetic pathways were found to be applicable for the introduction of a variety of functional groups. Chemically modified carbon nano-onions were probed in different fields of application and have been revealed to be a promising nanomaterial that attracts a growing interest among researchers and opens new avenues for investigation. Currently, carbon nano-onions can only be produced in gram-scale quantities by mechanical stressing of commercially available nano-diamonds. Alternatively, this production is performed by the combustion of naphthalene, and by arc flashes between graphite electrodes under water. However, current methods of manufacturing carbon nano-onions are unable to produce industrial levels of product in a short period of time. The availability of large quantities of CNOs would open up applications for these exotic nano materials.

Advantageously, the plasma arc systems described herein can produce CNOs in large quantities. One, single, small plasma system as described herein is capable of producing kilograms of the carbon nano-onions in a matter of a few days. Multiple parallel systems can increase production quantities and provide rapid delivery at industrial levels, on site and on demand. The reason for this ability is that the expanding arc produces a very high temperature, uniform, and large plasma field to synthesize the CNOs. Generally, the arc electrodes that produce these arcs must be arranged in alternating polarity to sustain a stable, uniform, and conjoined arc field. It is this high temperature conjoined active arc field that makes the high-rate synthesis of carbon nano-onions possible. Advantageously, the arc electrode plasma systems described herein can use any gas, preferably, argon, hydrogen and/or nitrogen, to form the plasma. In one iteration, graphite electrodes may be used to produce high purity CNOs. Feedstock for the process can use high purity carbon black derived from cracking of high purity hydrocarbon gases or liquids, high purity graphite powder or other carbon-rich materials.

In addition to producing carbon nano materials, the high temperature of the plasma arc systems described herein can also be used to crack hydrocarbons, such as methane. Methane is a more potent greenhouse gas than carbon dioxide and is a material global warming concern. Global warming can lead to polar ice cap melting, sea level rise and loss of land mass. Methane sequestration is an international effort to reduce global warming. Cracking hydrocarbons to produce hydrogen and carbon, and then sequestering the carbon, reduces greenhouse gases and promotes the development of a hydrogen economy.

In particular, methane can be cracked and reduced to hydrogen and solid carbon. However, current technologies lack the ability to efficiently generate a sufficiently high temperature environment to completely crack methane. The result is partial cracking with higher molecular weight hydrocarbons as impurities. Among all of the hydrocarbon gases, methane is the most stable. As a result, the complete cracking of methane to hydrogen and solid carbon is extremely difficult due to the very high temperatures required. The plasma arc systems described herein have the ability to efficiently generate a temperature field capable of fully cracking methane.

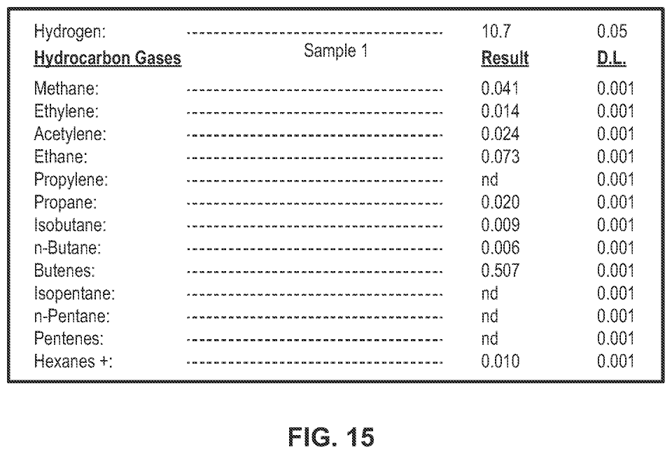

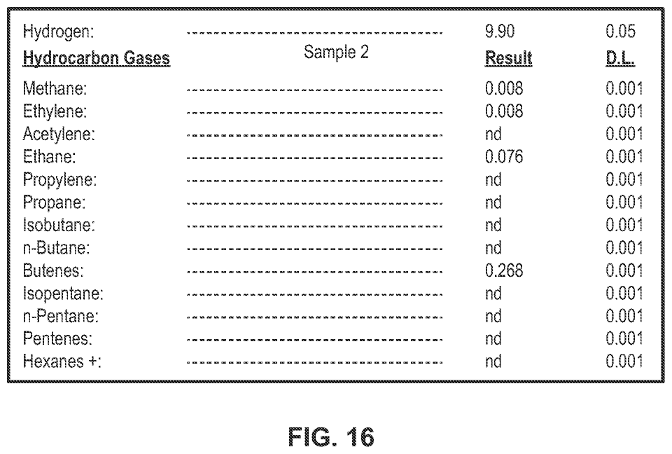

In particular, referring to FIG. 15, test results are shown. Using the plasma arc system previously described to crack methane, only 0.041% CH₄ residue was detected. Thus, 99.96% of the feed methane was cracked to hydrogen and solid carbon. The table of FIG. 15 illustrates a product gas analysis. The total concentration of impurity hydrocarbon gases was 6.17% in the product gas and the hydrogen concentration was 93.83%. In another gas sample, the results of which are illustrated in FIG. 16, only 0.008% CH₄ residue was detected and this shows that 99.99% of the feed methane was cracked to hydrogen and solid carbon. The amount of impurity hydrocarbon gases significantly decreased, and their total concentration was 3.51%, while the hydrogen concentration was 96.49% in the product.

With the demonstration of almost 100% cracking of CH₄ to H₂ and solid carbon, it is conceivable that the cracking of other hydrocarbon gases in the plasma arc system could approach 100%. It is also understood that the carbon black produced from methane or other hydrocarbon cracking in these arc configurations will contain CNOs and other nano-carbon allotropes.

As noted above, many of the plasma reactors or systems described herein (e.g., with respect to FIGS. 1-9 at least), have sets of opposed arc electrodes. During operation, an unconfined arc is created between a cathode electrode and an anode electrode and a working gas is then passed through the arc, therein creating plasma. The working gas is injected into a plasma chamber around the cathode electrode and the anode electrode which enables the passing working gas to help cool the cathode electrode and the anode electrode. Moreover, as described with respect to FIGS. 5 and 6, it is beneficial to keep the working gas in a confined stream that follows the path of the arc between the cathode electrode and the anode electrode. In this manner, the working gas is exposed to the heat of the arc for a longer period of time. To help keep the working gas in a confined stream, a rotational vortex may be created in the working gas as it flows into the plasma chamber wherein the mid-axis of the vortex is oriented to follow the path of the arc (as illustrated in FIG. 6).

When the cathode electrode and the anode electrode are positioned on directly opposite sides of a plasma chamber, as has been the case in the past, creation of the same rotational vortex in the working gas as this gas exits both the cathode electrode and the anode electrode causes the two vortexes to spin in opposite directions when they intersect in the center of the plasma chamber. The opposite spin causes the vortexes to cancel or destructively interact, which causes the working gas to disperse. This operation may create significant instabilities for the arc column.

FIGS. 17-19 depict or illustrate a plasma unit, which may be, for example, any of the plasma units 16, 100, 120, 130, 340 and 350 of FIGS. 1-3, 7-9, 12 and 13, which can be used to better direct flow of working gas in the reaction chamber. Referring to FIG. 17, a plasma arc system 410 may be used to enhance materials processing such as waste to energy conversion, wastewater destruction, nano materials synthesis, and methane cracking to produce hydrogen and nano-carbons. In FIG. 17, it can be seen that there is an anode electrode assembly 412 and a cathode electrode assembly 414 set in a plasma module on opposite sides of a plasma chamber 416. The anode electrode assembly 412 and the cathode electrode assembly 414 generate an arc 418 that extends across the plasma chamber 416 in any of the manners previously described herein.

A working gas 420 is passed through the anode electrode assembly 412 and the cathode electrode assembly 414 and operates to cool these assemblies 412, 414. Moreover, the working gas 420 is converted into plasma by the arc 418. As will be explained, the working gas 420 is directed into a reinforced vortex 422 as it passes through the electrode assemblies 412, 414. The reinforced vortex 422 spins the working gas 420 and allows the working gas 420 to propagate along the arc 418 without dispersing or dispersing to a lesser amount than in previous systems which introduced working gas into a reaction chamber via one or more electrodes.

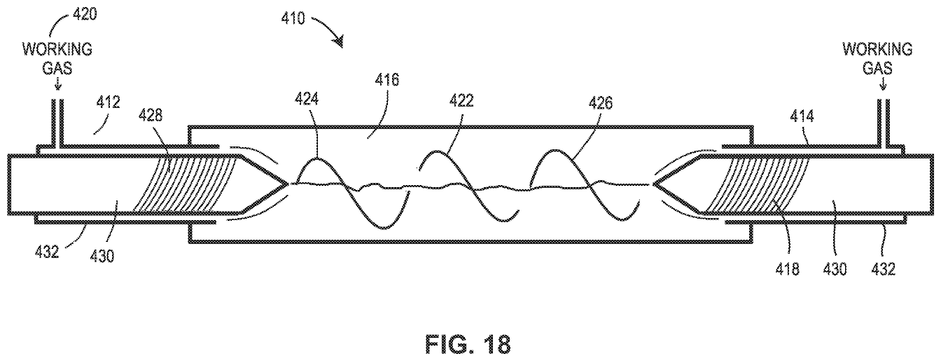

As better illustrated in FIG. 18, however, the first vortex 424 exiting the anode electrode assembly 412 spins in a first direction (when looking out from the tip of the first electrode 412), which can be either clockwise or counterclockwise, while the second vortex 426 exiting the cathode electrode assembly 414 is configured to spin in the opposite direction (when looking out from the tip of the electrode 414). Because the anode electrode assembly 412 and the cathode electrode assembly 414 are oriented 180 degrees apart on opposite sides of the plasma chamber 416, they form mirror images opposite to each other, and the first and second two vortexes 424, 426 will now physically align. Furthermore, the first vortex 424 and the second vortex 426 spin in the same direction due to the different spins induced into these vortexes at the electrodes 412 and 414. The result is that the first vortex 424 and the second vortex 426 reinforce each other to create the single reinforced vortex 422 that spans fully across the plasma chamber 416. The reinforced vortex 422 travels the same pathway as the arc 418 so that the working gas 420 is kept close to the arc 418 without dispersing. This configuration improves the arc column stability and creates more plasma per unit of working gas 420.

As illustrated in FIG. 18, in both the anode electrode assembly 412 and the cathode electrode assembly 414, the working gas 420 passes through grooves 428 that are formed on an electrode body or core 430 and between a surrounding housing 432. In the anode electrode assembly 412, the grooves 428 are formed into either a clockwise or counterclockwise spiral. As such, when the working gas 420 passes through the anode electrode assembly 412, the working gas 420 will spin in the grooves 428. When the working gas 420 exits the grooves 428, the spinning movement remains and the working gas 420 progresses in a vortex (the vortex 424).

However, the cathode electrode assembly 414 has grooves 428 (also disposed in an electrode body or core 430 and between a surrounding housing 432), but the grooves 428 of the cathode electrode assembly 414 rotate in the opposite direction to those used in the anode electrode assembly 412 (when viewed from the same direction, e.g., looking out from the base to the tip of the electrodes 413, 414)). Accordingly, the working gas 420 exits the cathode electrode assembly 414 with a vortex of opposite spin (the vortex 426) with respect to the electrode 414. However, because the first vortex 424 exiting the anode electrode assembly 412 is 180 degrees opposite the second vortex 426 exiting the cathode electrode assembly 414, they are mirror images opposite to each other, and these two vortexes 424, 426 spin in the same direction or circular motion within the plasma chamber 416. As a result, the two vortexes 424 and 426 constructively add to one another to create the vortex 422 which spans the entire distance between the anode electrode assembly 412 and the cathode electrode assembly 414. This stable vortex provides for better gas column formation and helps prevent the working gas 420 from disbursing in or near the center of the chamber 416, which leads to better arc formation and creation of plasma within the chamber 416.

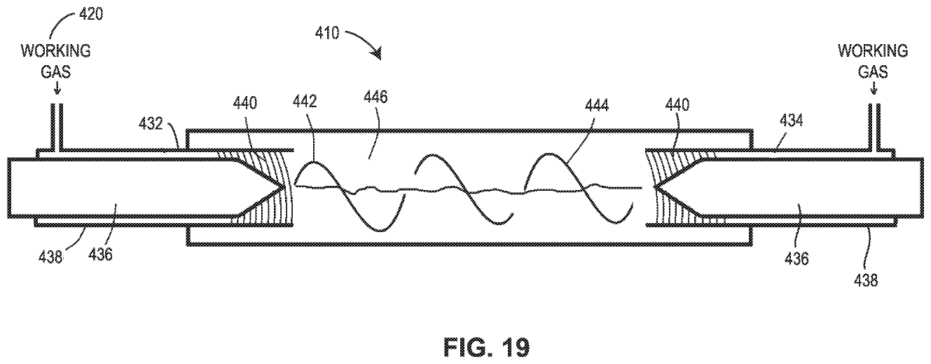

Referring to FIG. 19, an alternate embodiment has an anode electrode assembly 432 and a cathode electrode assembly 434, each of which has electrode core 436 and a surrounding housing 438. Grooves 440 are formed on the interior surface of the housings 438 (which is part of a working gas passage) so that the working gas 420 passes through grooves 440. In the anode electrode assembly 432, the grooves 440 are formed into either a clockwise or counterclockwise spiral when looking out of the housing 438 in the longitudinal direction. As such, when the working gas 420 passes along the anode electrode assembly 432, the working gas 420 will spin in the grooves 440 in the determined circular direction. When the working gas 420 exits the grooves 440 the spinning movement remains and the working gas 420 progresses in a first vortex 442.

However, the cathode electrode assembly 434 has grooves 440 that rotate in the opposite direction to those used in the anode electrode assembly 432 when looking out of the housing 438 of the cathode electrode assembly 434 in the longitudinal direction. Accordingly, the working gas 420 exits the cathode electrode assembly 434 with a second vortex 444 of opposite spin. However, because the first vortex 442 exiting the anode electrode assembly 432 is 180 degrees opposite the second vortex 444 exiting the cathode electrode assembly 434, they are mirror images opposite to each other, and these two vortexes 442, 444 spin in the same direction within the plasma chamber 446. Again, the two vortexes 442 and 444 constructively add to one another to create a vortex that spans the entire distance between the anode electrode assembly 432 and the cathode electrode assembly 434. This stable vortex provides for better gas column formation and helps prevent the working gas 420 from disbursing in or near the center of the chamber 446, which leads to better arc formation and creation of plasma within the chamber 446.

Of course, the plasma arc modules having electrode assemblies which produce a better gas vortex have been described herein in only two exemplary embodiments, for the purposes of illustration and discussion. However, these modules could be produced in other manners as well and so the illustrated embodiments are merely exemplary and should not be considered a limitation when interpreting the scope of the claims. For example, the grooves described above could be disposed on other surfaces of the electrodes or electrode assemblies that are exposed to the flow of working gas into the reaction chamber. Additionally, the grooves described herein could be disposed on multiple surfaces, such as on both the electrode body or core as illustrated in FIG. 18 and on the interior surface of the electrode housing as illustrated in FIG. 19. Alternatively, one of the pair or set of electrodes (e.g., the cathode electrode) may have the grooves formed on one of the electrode body or the interior surface of the electrode housing while the other one of the pair or set of electrodes (e.g., the anode electrode) may have the grooves formed on the other one of the electrode body or the interior surface of the electrode housing. Moreover, it will be understood that the use of arc electrodes disposed on opposite sides of a reaction chamber that introduce a working gas into the chamber using differently directed vortexes to cause the vortexes to constructively add in the chamber, as described herein, can be used in plasma or reaction chambers with any number of such oppositely opposed sets of electrodes (including one set or multiple sets), including for example, in any of the plasma units described herein, but especially in the plasma units depicted in FIGS. 1-3, 7-9, 12 and 13. In this case, the oppositely opposed electrodes will have grooves therein that cause the working gas to spiral in different circular directions as they leave the electrode assemblies, but the opposed electrodes may be electrodes from the same or from different sets or pairs of electrodes. Thus, the opposed electrodes (those disposed directly opposite one another across the reaction chamber or reaction zone) may be an anode and a cathode electrode of the same set of electrodes, may be an anode and a cathode electrode of different sets of electrodes, may be two anode electrodes of different sets of electrodes or may be two cathode electrodes of different sets of electrodes. Still further, these electrodes with working gas vortex creation can be used in other than circular or cylindrical reaction chambers, including in rectangular, square, octagonal, etc. chambers or in tube shaped chambers in which the electrodes are disposed at the longitudinal ends of the tube. Likewise, the grooves in the various electrode assemblies may have grooves of any desired pitch (that is, the inter-groove spacing between the adjacent grooves of the spiral) to create tighter or looser vortexes. Additionally, the groove pitches of the different electrode assemblies or electrodes of a particular pair of electrodes (i.e., for the anode electrode and the cathode electrode) may be the same or may be different.

Advantageously, the gasifiers described herein provide for or implement an ultra-high temperature ionic gasification process that can be used in an environmentally friendly manner to dispose of dried biosolids from, for example, wastewater treatment plants as well other wastes, such as municipal solid waste (MSW) to produce, for example, renewable syngas that can be used to provide heat, power, renewable fuels, renewable hydrogen, and/or renewable chemical production. The systems described herein do so by generating electrical arcs across the interior (e.g., diameter) of the gasifier reaction chamber creating a localized, controlled temperature in excess of 3000 C and in some cases in excess of 5000 C, along with ionic gas or particles (plasma). This ultra-high temperature gasification zone and active ionic environment combine to very effectively and efficiently break down molecules into their constituent atoms, in a process called complete molecular dissociation. This ultra-high temperature ionic zone will also rapidly decompose impurities in the feed stock such as microplastics and PFAS (Per- and Polyfluorinated Substances). Moreover, as the gasified stream exits the gasification zone, a rapid, controlled temperature drop recombines these atoms, forming a very pure syngas with no or very little system scaling, making it suitable for treating wastewater residuals, focusing on drying and gasifying solid residuals for energy production and PFAS destruction. This rapid temperature drop also tends to maximize production of desirable molecules like hydrogen and carbon monoxide while minimizing the production of less desirable molecules such as water, ammonia, and carbon dioxide. Materials to be processed are preferably dried or partially dried solids with high solid content.

Still further, it will be understood that the gasifiers described herein can be used in a gasifier mode in which oxygen is present in the reaction chamber thereof, or in a pyrolysis mode in which no or limited oxygen is present in or introduced into the reaction chamber.

Although the presently described jet and plasma arc systems can be embodied in many ways, only some exemplary embodiments have been selected for the purposes of illustration and discussion. Moreover, it will be understood that the embodiments of the present invention that are illustrated and described herein are merely exemplary and that a person skilled in the art can make many variations to those embodiments. All such embodiments are intended to be included within the scope of the present invention as defined by the claims.

1. A gasifier, comprising:
an input for receiving a material to be processed;
an output;
one or more plasma units, each plasma unit including;
an outer wall that defines an internal reaction zone; and
one or more sets of electrode assemblies, wherein each set of electrode assemblies includes an anode electrode and a cathode electrode, wherein each of the anode electrode and the cathode electrode includes an electrode tip exposed to the reaction zone;
wherein each set of electrode assemblies is connected to a power supply for energizing the anode electrode and the cathode electrode with a power signal to cause arcing in the reaction zone between the anode electrode and the cathode electrode;
wherein the one or more plasma units are disposed between the input and the output so that the reaction zones of the one or more plasma units define a reaction chamber such that the material to be processed flows through the reaction chamber from the input to the output and is subject to the arcing produced by the one or more sets of electrode assemblies in the one more plasma units; and
a plasma torch disposed adjacent the reaction chamber and having an output that emits plasma into the reaction chamber.

2. The gasifier of claim 1, wherein the plasma torch is disposed near the input.

3. The gasifier of claim 1, wherein the plasma torch is disposed near the output.

4. The gasifier of claim 1, wherein the reaction chamber has a longitudinal axis extending from the input to the output and wherein the plasma torch is oriented to direct the plasma in a stream longitudinally into the reaction chamber.

5. The gasifier of claim 1, including a plurality of plasma units and wherein the plasma torch is oriented to direct the plasma into the reaction zone of at least two of the plurality of plasma units.

6. The gasifier of claim 1, wherein the plasma torch is disposed in one of the one or more plasma units and extends through the outer wall of the one of the one or more plasma units to direct plasma radially into the reaction zone of the one of the one or more plasma units.

7. The gasifier of claim 1, wherein each of the electrode assemblies includes one or more working gas passageways and a working gas outlet that conducts a working gas into the reaction zone of one of the plasma units.

8. The gasifier of claim 7, wherein the working gas emitted via the one or more electrode assemblies is subjected to one or more arcs within the reaction zone of the one of the plasma units to form a plasma.

9. The gasifier of claim 1, wherein the plasma emitted by the plasma torch ignites one or more arcs between the anode electrode and the cathode electrode of at least one set of electrode assemblies.

10. The gasifier of claim 1, wherein each of the one or more plasma units is circular in cross section defining a cylindrical reaction zone.

11. The gasifier of claim 10, including a plurality of plasma units stacked longitudinally to define an elongated cylindrical reaction chamber.

12. The gasifier of claim 11, wherein each of the plurality of plasma units includes two or more sets of electrode assemblies.

13. The gasifier of claim 12, wherein the plasma torch emits a plasma flame that passes through the reaction zone of at least two of the plasma units to interact with one or more arcs produced by the electrode assemblies of each of the at least two plasma units.

14. A gasifier, comprising:
a reaction chamber formed by a continuous outer wall extending between a first open end and a second open end defining a longitudinal axis between the first open end and the second open end;
at least one set of electrodes extending through the outer wall between the first open end and the second open end into the reaction chamber, each set of electrodes including an anode electrode and a cathode electrode, wherein each of the anode electrode and the cathode electrode includes an electrode tip and wherein each set of electrodes is connected to a power supply for energizing the anode electrode and the cathode electrode with a power signal to cause arcing in the reaction chamber between the anode electrode tip and the cathode electrode tip; and
a plasma torch disposed adjacent the reaction chamber and having an output that emits plasma into the reaction chamber.

15. The gasifier of claim 14, wherein the plasma torch emits plasma as a plasma flame into the reaction chamber.

16. The gasifier of claim 14, wherein the anode electrode and the cathode electrode extend into the reaction chamber in a first plane perpendicular to the longitudinal axis, and wherein the plasma torch is disposed perpendicularly to the first plane to emit the plasma into the reaction chamber perpendicularly to the first plane.

17. The gasifier of claim 14, wherein the anode electrode and the cathode electrode extend into the reaction chamber in a first plane perpendicular to the longitudinal axis, and wherein the plasma torch is disposed to emit the plasma into the reaction chamber in a direction parallel to the first plane.

18. The gasifier of claim 14, wherein the anode electrode and the cathode electrode extend into the reaction chamber in a first plane perpendicular to the longitudinal axis, and wherein the plasma torch is disposed to emit the plasma into the reaction chamber in a direction that is parallel to and within the first plane.

19. The gasifier of claim 14, wherein the anode electrode and the cathode electrode extend into the reaction chamber in a first plane perpendicular to the longitudinal axis, and wherein the plasma torch is disposed to emit the plasma into the reaction chamber in a direction that intersects the first plane at a non-zero angle.

20. The gasifier of claim 14, further including a material input and a material output, wherein the at least one set of electrodes is disposed so that the anode electrode and the cathode electrode of the set of electrodes are disposed laterally across the reaction chamber and wherein the plasma torch is oriented to direct the plasma in a stream longitudinally into the reaction chamber.

21. The gasifier of claim 20, wherein the reaction chamber includes a plurality of plasma units, each plasma unit including an outer wall defining a reaction zone within the confines of the outer wall and at least one set of electrodes, and wherein the plasma units are stacked on each other to align the outer walls of the plasma units so that the reaction zones of the plurality of plasma units form the reaction chamber.

22. The gasifier of claim 21, wherein the plasma torch is oriented to direct the plasma into the reaction zone of at least two of the plurality of plasma units.

23. The gasifier of claim 14, wherein the reaction chamber includes one or more cylindrical plasma units formed by a cylindrical outer wall, and wherein the plasma torch is disposed in one of the one or more plasma units and extends through the outer wall of the one of the one or more plasma units to direct plasma radially into the reaction zone of the one of the one or more plasma units.

24. The gasifier of claim 14, wherein one or more of the electrodes includes one or more working gas passageways and a working gas outlet that conducts a working gas into the reaction chamber.

25. The gasifier of claim 24, wherein the working gas emitted via the one or more electrodes is subjected to one or more arcs within the reaction chamber during operation of the gasifier.

26. The gasifier of claim 14, wherein the plasma emitted by the plasma torch ignites one or more arcs between the electrodes of a set of electrodes during operation of the gasifier.

27. A method of processing a material, comprising:
receiving an input material to be processed within a reaction chamber;
energizing one or more sets of electrodes, each set of electrodes including an anode electrode and a cathode electrode, each anode electrode and cathode electrode having an electrode tip exposed to the reaction chamber;
creating an electrical arc between the anode electrode tip and the cathode electrode tip within the reaction chamber to subject at least some of the input material to electrical arcing;
creating plasma in a plasma torch; and
injecting the plasma from a plasma torch into the reaction chamber to expose at least some of the input material to the plasma from the plasma torch.

28. The method of claim 27, wherein injecting the plasma from the plasma torch includes emitting a plasma flame into the reaction chamber.

29. The method of claim 28, wherein creating an electrical arc between the anode electrode and the cathode electrode within the reaction chamber includes creating the electrical arc in a first plane laterally across the reaction chamber, and wherein emitting the plasma flame into the reaction chamber includes emitting the plasma flame perpendicularly to the first plane.

30. The method of claim 28, wherein creating an electrical arc between the anode electrode and the cathode electrode within the reaction chamber includes creating the arc in a first plane laterally across the reaction chamber, and wherein emitting the plasma flame into the reaction chamber includes emitting the plasma flame in a direction parallel to the first plane.

31. The method of claim 28, wherein creating an electrical arc between the anode electrode and the cathode electrode within the reaction chamber includes creating the arc in a first plane laterally across the reaction chamber, and wherein emitting the plasma flame into the reaction chamber includes emitting the plasma flame in a direction parallel to and within the first plane.

32. The method of claim 28, wherein creating an electrical arc between the anode electrode and the cathode electrode within the reaction chamber includes creating the arc in a first plane laterally across the reaction chamber, and wherein emitting the plasma flame into the reaction chamber includes emitting the plasma flame into the reaction chamber at a non-zero angle with respect to the first plane.

33. The method of claim 28, wherein creating an electrical arc between the anode electrode and the cathode electrode within the reaction chamber includes creating the arc in a first plane laterally across the reaction chamber, and wherein emitting the plasma flame into the reaction chamber includes emitting the plasma flame such that the plasma flame crosses the first plane.

34. The method of claim 27, wherein energizing the one or more sets of electrodes includes energizing a plurality of sets of electrodes at a longitudinal location with respect to the input to create multiple arcs across the reaction chamber at the longitudinal location.

35. The method of claim 27, wherein energizing the one or more sets of electrodes includes energizing a first set of electrodes at a first longitudinal location with respect to the input to create at least one arc across the reaction chamber at the first longitudinal location and energizing a second set of electrodes at a second longitudinal location with respect to the input that is different than the first longitudinal location, to create at least one arc across the reaction chamber at the second longitudinal location.

36. The method of claim 35, wherein injecting the plasma from the plasma torch into the reaction chamber includes injecting a plasma flame into the reaction chamber such that the plasma flame crosses the arc created by the first set of electrodes but does not cross the arc created by the second set of electrodes.

37. The method of claim 27, wherein energizing the one or more sets of electrodes includes energizing a first plurality of sets of electrodes at a first longitudinal location with respect to the input to create a first plurality of arcs across the reaction chamber at the first longitudinal location and energizing a second plurality of sets of electrodes at a second longitudinal location with respect to the input that is different than the first longitudinal location, to create a second plurality of arcs across the reaction chamber at the second longitudinal location.

38. The method of claim 37, wherein injecting the plasma from the plasma torch into the reaction chamber includes injecting a plasma flame into the reaction chamber such that the plasma flame crosses the first plurality of arcs created by the first plurality of sets of electrodes but does not cross the second plurality of arcs created by the second plurality of sets of electrodes.

39. The method of claim 37, wherein injecting the plasma from the plasma torch into the reaction chamber includes injecting a plasma flame into the reaction chamber such that the plasma flame crosses both the first plurality of arcs created by the first plurality of sets of electrodes and the second plurality of arcs created by the second plurality of sets of electrodes.

40. The method of claim 27, wherein creating an electrical arc between the anode electrode and the cathode electrode within the reaction chamber includes creating the arc radially across a circular reaction chamber by an anode electrode and a cathode electrode disposed across the circular reaction chamber, and wherein emitting the plasma flame into the reaction chamber includes emitting the plasma flame radially into the reaction chamber.

41. The method of claim 40, wherein creating an electrical arc between the anode electrode and the cathode electrode within the reaction chamber includes creating the arc at a first longitudinal location with respect to the input, and wherein emitting the plasma flame into the reaction chamber includes emitting the plasma flame radially into the reaction chamber at the first longitudinal location.

42. The method of claim 27, further including injecting working gas into the reaction chamber from an electrode assembly including the anode electrode or the cathode electrode.

43. The method of claim 42, further including creating plasma from the working gas by exposing the working gas to an arc created between the anode electrode and the cathode electrode.

44. The method of claim 27, further including igniting one or more arcs between a set of electrodes within the reaction chamber using the plasma from the plasma torch.

45.-125. (canceled)
